(19) United States
(12) Patent Application Publication
(10) Pub. No.: US 2024/0207861 A1
(43) Pub. Date: Jun. 27, 2024

(54) Apparatus, System And Method For Comminution

(71) Applicant: Comre IP Pty Ltd, Fig Tree Pocket QL (AU)

(72) Inventor: Malcolm Strathmore Powell, Hornsby (AU)

(21) Appl. No.: 17/420,822

(22) PCT Filed: Jan. 6, 2020
(86) PCT No.: PCT/IB2020/050065

§ 371 Date: Jul. 6, 2021

(30) Foreign Application Priority Data
Jan. 5, 2019 (AU) 2019900030

(51) Int. Cl. B02C 4/02; B02C 4/32; B02C 4/42

(52) U.S. Cl. CPC B02C 4/02; B02C 4/32; B02C 4/42

(57) ABSTRACT

A roller crushing machine for progressively crushing solid particulate material into finer size particulates is disclosed. It has a plurality of spaced-apart crushing stages arranged so that, a flow path of particulates travels consecutively from one crushing stage to the next, in between the outer peripheral surfaces of the rollers, which are adjustably displaceable from each other by a lateral distance not greater than a desired maximum particulate size from that crushing stage. When a flow of solid particulate material passes between cach of the pairs of rollers, the predetermined lateral distance encountered by the flow path can be controlled to be of a dimension which is sufficiently operably narrow to only apply a sufficient compression breakage force to just the topsize of the particulates at that size range of preselected solid particulate material, and a mono-layer flow of particles passing therethrough, to minimize energy consumption in that stage.

### TECHNICAL FIELD

This disclosure relates generally to comminution and more particularly to comminution using roller crushing machines. The disclosure is concerned with the design of a roller crushing apparatus as well as methods for optimising the use of energy in such apparatus when crushing particulate material, such as mineral ores. However other types of crushing machines which have repeatable motion crushing elements are also disclosed.

### BACKGROUND OF THE DISCLOSURE

Currently available comminution equipment used to crush a run-of-mine mineral orebody down to a particulate top-size of minus 100 μm normally requires the use of multiple stages of crushing and grinding, which can often necessitate the sequential use of combinations of different types of crushing and grinding machines. Typical comminution machines, such as jaw crushers, cone crushers, roller crushers, hammer mills etc, may be chosen, because they are designed to operate within a certain range of particulate top-size for feed input and for product output.

The use of a combination of devices may also necessitate the use of intermediate classification separation apparatus, for example to remove the build-up of ultrafine particulates which are produced during grinding. Combinations of devices may also require the use of recycle streams to ensure that particulates are sufficiently crushed to a chosen product top-size, before the ore material can be passed into another type of comminution apparatus.

In most comminution machines there is little or no control on which particles are broken. The tendency is for multiple particles to bridge the gap between the two crushing elements (such as opposing jaws in a jaw crusher, or counter-rotating rollers in a twin-roll crusher) and then for each of those bridging particles to be fractured during the crushing step. A post-equipment classification device (such as a screen or cyclone or air classifier) is then used to direct certain particulates onward for further processing, as well as to direct those particulates which need to be recycled to move back upstream for further breakage. Comminution conducted in this manner inevitably leads to over-grinding of a large portion of the material, that is, to a particulate size which is actually below the minimum product top-size needed for effective liberation of the valuable minerals.

The classifiers that suspend particles in air or water suffer from selection by density as well as selection by particulate size, leading to further over-grinding of the denser phase and under-grinding of the lower density phase. As a result, considerable energy is wasted in over-grinding material, leading to a higher cost in terms of energy usage than was needed to achieve the desired liberation size.

There is a need for an improved comminution system which can overcome such limitations by applying a size reduction in a controlled sequence of steps that achieves a desired a maximum top-size, whilst minimising the production of material below the required liberation size.

### SUMMARY OF THE DISCLOSURE

In a first aspect, embodiments are disclosed of a roller crushing machine for progressively crushing solid particulate material into finer size particulates, the machine comprising a plurality of spaced-apart crushing stages arranged so that, during use, a flow path of said particulates travels consecutively from one crushing stage to the next, each crushing stage comprising a pair of rollers, each mounted for rotational motion about an elongate axis, each roller of said pair along with its respective drive transmission mechanism representing a functional unit which is located at a support; and
respective outer peripheral surfaces of the rollers in a crushing stage being adjustably displaceably set apart from each other by a predetermined lateral distance not greater than a desired maximum particulate size from that crushing stage, said lateral distance being in alignment with the flow path and perpendicular to the flow direction of solid particulate material which is received in use onto, and drawn between, the pair of rollers;
wherein when progressing consecutively through the crushing stages, the predetermined lateral distance encountered by the flow path is adjustable to be relatively smaller than the predetermined lateral distance in a preceding crushing stage by a preselected numerical ratio (also known as a “reduction ratio”) which is within the range of greater than 1 and less than 2; and
the rollers in said crushing stages are operable with a rate of rotational motion which is at least the same as, or faster than that of the rollers located in any preceding crushing stage.

In some embodiments, the preselected numerical ratio is within the range of 1.2 to 1.5, and in yet further specific embodiments, it is within the range of 1.25 to 1.33. In other words, the preselected numerical ratio is calculated by the relative measure of the lateral distance of a preceding stage divided by that of current stage. Such numerical ratios (or reduction ratios) used between each crushing stage in this disclosure are consistent with the minimum reduction ratios required for single particle fracture as established in laboratory testing by the inventor.

The roller crusher machine can handle a feed material of large size particulates, which is passed through a sequence of crushing stages, which in one exemplary embodiment are arranged in a vertical stack. In one such arrangement (shown later in the illustrations in the present specification), the support for each of the components of the crushing stages is in the form of a four sided open frame structure, to which the various components of the crushing stages (such as the individual functional units, motors etc) can be fixedly attached. A vertical stack is formed by placing a plurality of the frames one atop another, and joining them by means of fasteners, or the like.

In further embodiments, instead of an open framework, the support for each of the functional units may be present in other forms, such as a planar baseplate with the necessary orifice through which the flow path is directed in use, and with respective baseplates having some other means (such as legs, flanges or other projections) for being joined in a fixed spatial relationship directly to one another, or alternatively being fastened onto an exo-skeleton type of structure.

In some embodiments of a stack, each crushing stage comprises a pair of cylindrically-shaped rollers which are arranged in a parallel orientation with one another, with a lateral distance (or “flow path”, or “flow path gap”, or “roller gap width”, or “roller gap” or “rolls gap”) located between each roller pair, defined as the distance between the peripheral cylindrical surfaces of respective roller pairs when proceeding sequentially through the stack, and specifically, in a downward direction if the stack is arranged vertically with respect to surrounding ground. In an exemplary embodiment, the roller crushing machine is arranged with a stack of like crushing stages, but in which the lateral distance or roller gap dimension becomes steadily smaller when moving into the stack away from the point at which the feed solid particulate material enters the stack. This gradual, sequential reduction in the roller gap provides the basis for a gradual, stage-wise size reduction of solid particulates, such as a mineral ore, when the crushing machine is in use.

Throughout this specification, when the term “stack” is used, it refers to a plurality of the aforementioned crushing stages, placed adjacent to one other and functionally interconnected to form a rigid structure.

In use, the solids are passed slowly, for example via a suitable feeder inlet device such as a vibratory feeder, onto the uppermost pair of rollers in the first crushing stage of the roller crusher machine. The entry of the feed solid particulate material for crushing into the predetermined lateral distance between each pair of rollers is performed in a very specific manner. The particles are spread along the length of the pair of rollers so as to form a single, evenly distributed layer of material. This layer should be no thicker than the largest particles and there should be no particles stacked upon other particles in a manner that can bridge and pack into a bed when passed into the gap. Such a feed presentation is defined as a “mono-layer”.

In the disclosed method, the feed particulate material (in the form of a stream of particles with a relatively large top-size) is passed as a monolayer into the pair of rollers that form the first crushing stage of the machine. The gap for the first pair of rollers is arranged so as to provide a sufficient degree of compression to the top-size of those particulates to effectively break them in just a single fracture event, but not to induce secondary breakage of the progeny. That is, there should be no re-crushing of the broken fragments which are the result of the primary breakage event. Fractured particles will generally be irregular in shape and some degree of fine particle generation is unavoidable. The fractured particles should not be compressed to the extent that they become supported by, or confined by, other particles during this breakage event. Finally, the mono-layer feed must be established to a sufficient extent to prevent a packed bed of particles forming between the rolls, such that particles bridge the gap and are then broken under bed-breakage conditions.

Throughout this specification, when the term “top-size” is used, it refers to the solid particulates which are present in the feed material which have a minimum width greater than the predetermined lateral distance of that crushing stage, and can refer to a particular size at one of the crushing stages.

Breakage by crushing using such a one-time, primary particle crushing technique provides the most energy-efficient technique for size reduction in a single stage, rather than applying a large amount of energy in a single impact across a bed of particles (also known as “bed-breakage”).

By operating with a single particulate breakage configuration, the one-time crushed product solids from the first crushing stage then will be passed into the subsequent crushing stages, where a different (smaller) predetermined lateral distance between the respective next set of rollers exists, and so on, until the particulates exit the last of the sequence of crushing stages. In each instance, the predetermined lateral distance between said pair of rollers in a crushing stage is arranged so as to provide a sufficient degree of compression to the top-size of those particulates entering that stage in order to effectively break them just one time, but not to induce secondary breakage (bed breakage) of the progeny—that is, no re-crushing of the broken fragments which are the result of the primary breakage event.

The reduction ratios used between each crushing stage in this method range from above 1.0 (no reduction) to a more usual 1.5 for competent, rough particles. As described in more detail herein in relation to single particle breakage, the reduction ratio can be above 1.1 and should preferably be below 1.4 in order to maintain energy efficiency of the process. For example, the ratio can be dependent on the fracture properties of the material being crushed and may vary for different top sizes of the same material, such that the optimal reduction ratio for each stage in the device may differ from the preceding stages. Progeny particles tend to break to less than half the parent particle size, so it may be feasible to operate at slightly higher reduction ratios with only a small loss in efficiency while still preserving the mono-layer conditions. The maximum for this extended operating range would be a reduction ratio of less than around 2. The gaps between each roller pair are adjustable in a direction perpendicular to the particle flow path, and within a range commensurate with the required reduction ratios between each stage of between 1.0 and 2.0. Such small reduction ratios within the range of greater than 1 and less than 2 for gradual, single particle breakage crushing are significantly lower than the numerical ratios used in any known prior art crushing machines, which can be as much as 40 in a typical high pressure grinding roll (HPGR) machine.

In some embodiments, the predetermined lateral distance between the roller pairs located in the or each crushing stage(s) are in respective vertical alignment, such that in use, said flow path of particulates passing therethrough is also vertical, and the outer peripheral surfaces of the roller pairs in the crushing stages are horizontally adjustably displaceable with respect to each other.

In some other embodiments, the said predetermined lateral distances may not be in vertical alignment, however particulate solids can flow onto the region directly above the next consecutive pair of rollers via a chute, channel or pipe bend of an appropriate shape.

In some alternate embodiments, the predetermined lateral distance between the roller pairs located in the or each crushing stage(s) are in respective angled alignment in relation to vertical, said flow path of particulates passing therethrough is also angled other than in a vertical orientation, and the outer peripheral surfaces of the roller pairs in the crushing stages are adjustably displaceable with respect to each other.

In some embodiments, the respective outer peripheral surfaces of the rollers in the functional units are horizontally adjustably spaced from each other by the predetermined lateral distance, and therefore are co-planar with one another, although in other configurations the rollers can be offset, depending on the requirements for the direction of the flow path of particulate solids through the machine (for example, the functional units may be in an angled stack).

This description pertains to the vertical embodiment of a crushing machine stack, but the application is intended to cover all such arrangements. Due to the acceleration of the particles between each progressive set of rolls, the rolls can become progressively aligned at an angle or even horizontally, as the influence of gravitational acceleration on the trajectory and velocity of particles between each set of rolls decreases in comparison with the increasing velocity of the particles.

The roller crushing stages may usually be stacked vertically on top of each other, but other arrangements may be possible and preferable in some situations. The velocity of the particles is driven by the circumferential velocity of the rolls and is aided by the flow of air through the rolls. In this way, the particle velocities may be increased in excess of 20 m/s along a typical stack of rollers. Consequently, the effect of gravitation acceleration between roller stages has a decreasing contribution to transferring the particles between stages. In light of this, the stack can be angled towards horizontal alignment as the particles progress down the stack.

The crushed particle stream from the first crushing stage then passes to each subsequent crushing stage, where a smaller gap between the respective set of rollers is maintained, and so on, until the particles exit the last of the sequence of crushing stages.

In some embodiments, movement of solid particulate material through a plurality of crushing stages arranged with a progressively decreasing predetermined lateral distance between the pairs of rotatable rollers, is facilitated by the use of a progressively increasing tangential velocity of operation of consecutive roller pairs. Each successive set of rollers needs a higher circumferential velocity than the preceding set, in order to compensate for the decreasing gap size and changes in particle bulk density. Consequently, the velocity of the particles is increased as they pass through the rollers and potentially high particle velocities are possible at the final roller stage.

At each crushing stage the correct roller speeds and gap between the pair of rollers in that crushing stage are arranged and maintained so as to:
a) maintain the particle mono-layer at that crushing stage;
b) provide a sufficient degree of compression to the top-size of those particulates entering that stage in order to effect single particle breakage on only the top-size particles, and
c) maintain a maximum particle occupancy of the final roller gap to achieve acceptable throughput rates, but without contravening the requirements for single particle breakage (s).

Although the rate of rotational motion of each roller is typically measured by its rotational speed (revolutions per unit of time), it is the tangential velocity, being the linear speed determined at the respective outer peripheral surface of a roller, which is the relevant physical condition for the particulates being crushed.

The rate of rotational motion of the roller(s) is imparted by a motor which is linked via the drive transmission mechanism to the or each respective roller. Thus, whether using same size diameter rollers or progressively smaller size diameter rollers, the operation of the roller pairs with a steadily higher circumferential (or tangential) velocity helps to pass the same amount of feed ore material through the steadily smaller lateral distance (or flow path gap, or roller gap width) between each roller pair, when proceeding sequentially through the stack of crushing stages, until all of the crushed material exits the machine.

As the lateral distance decreases between each set of rollers in the sequential crushing stages, it is noted that the increase in the circumferential (or tangential) velocity is not linear with the lateral distance.

In some embodiments, the particulate size reduction in top-size of the solid particulate material being fed into a crushing stage is dependent on the nip-angle of the rocks. The nip-angle is the angle subtended between the horizontal line passing through the centre of the pair of rollers and the point of contact of the solid particulate on a roller. Critical nip-angle is the maximum angle at which the solid particulate does not slip when gripped between the pair of rollers. Ensuring that the angle at which rocks are trapped between the rollers is less than the critical nip angle eliminates or minimises slip of the rock particle on the rollers as it is drawn between the rollers. The nip-angle and ore stiffness can then dictate the required torque to be provided to the rollers. In some embodiments in order to maintain the required nip angle, the diameter of the rollers can be progressively decreased over the sequence of crushing stages.

Typically, the throughput (for example, a quantity such as tonnes per hour), is determined by the bulk density of the feed solids material being passed into the lateral distance between each pair of rollers. The bulk density is determined by the ore density and the volumetric packing of the solid particulates (there is a voidage/empty volume between the solid particulates). As the topsize of the particulates being crushed is decreased, the bulk density of those particulates is expected to steadily increase (a finer size distribution will lead to better packing and higher bulk density).

Ultimately, experiments have shown that the multiple roller crushing machine of the present disclosure is capable of handling a feed of solid particulate material (such as sub-80 mm run-of-mine ore) and crushing it down to a final product size of minus 100 μm in a continuous manner, with a minimal requirement for recycle or classification streams. The machine can perform this function in an energy efficient way and in a single pass through, because of the application of a series of single-particle breakage steps to minimise the degree of breakage of particulates. Having less classification steps also means that the influence of other factors, such as the particle density and buoyancy of the particulates in the separation medium (usually water and sometimes air) does not arise. For example, a dense particulate which has the correct grind size, and has thus been liberated from gangue material in an ore may become incorrectly classified with larger particulates (for example, by use of a gravity separation device), causing those dense particulates to be recycled to the grinding process, and thus subjected to unnecessary re-grinding, and energy wastage.

In some embodiments, the drive transmission mechanisms in a crushing stage are each separately connected to a respective motor drive.

In some embodiments, the roller crushing machine is operatively connected to a control system which is arranged in use to adjust at least one of:
(i) the predetermined lateral distance between the roller pair located in a crushing stage, and
(ii) the rate of rotational motion of each roller in a roller pair located in a crushing stage.

In some embodiments, adjustment of the predetermined lateral distance between the roller pair located in a crushing stage is by relative displacement of at least one of the following components thereof: a functional unit; a component which is operably connected to the roller of a functional unit; or the roller of at least one of said functional units. In some forms of these, the relative displacement of the or each component can be accomplished by use of a motorised drive which is mounted thereto, and which has an operative connection via a control device to the control system. In some examples, these components of the crushing stage can be caused to slide or even to become decoupled and then a relative lateral displacement away from the other roller can occur.

In some embodiments, the pre-determined lateral distance is measurable in use by a distance measurement sensor which also has an operative connection via a signal transmission device to the control system. In one form of this in use, the control system takes an output signal from the signal transmission device for the distance measurement sensor, and provides an input signal to the control device for the motorised drive to adjust the relative displacement of said component(s) and therefore the predetermined lateral distance between the roller pairs.

In some embodiments, the adjustment of the relative displacement of the said components of a crushing stage in relation to that crushing stage is arranged to provide an operable precision of adjustment of the predetermined lateral distance between the roller pairs to within 20% thereof.

In some embodiments, the rate of rotational motion of a roller is operably measurable by using a motion sensor, which also has an operative connection via a signal transmission device to the control system. In some embodiments of this, in use a motor drive is operatively connected to the roller drive transmission mechanism in a crushing stage, said drive transmission mechanisms and motor drive having an operative connection via a control device to the control system.

In some embodiments in use, the control system takes an output signal from the signal transmission device for the motion sensor, and provides an input signal to the control device for the roller drive transmission mechanism and/or the motor drive, to adjust the rate of rotational motion of said rollers in a roller pair of a crushing stage. In some embodiments, each roller in the pair of rollers in any one of said crushing stages is operable with a tangential velocity within 5% of the respective other roller.

As a result of these connections, in some embodiments in use, the control system takes an output signal from the signal transmission device for the motion sensor, and provides an input signal to the control device for the roller drive transmission mechanisms and/or the motor drive, to adjust the rate of rotational motion of said rollers in a roller pair of a crushing stage. In some embodiments, each roller in the pair of rollers in any one of said crushing stages is operable with a rate of rotational motion within 5% of the respective other roller, in use.

In some embodiments, the outer peripheral surfaces of the rollers are made of a hardened material. Because each pair of rollers in any stage of the crushing machine is only required to apply a small degree of size reduction, it is expected that the wear rate on each roller will also be smaller, compared with, say, a comparable prior art crushing apparatus expected to perform a similar particulate size reduction (such as a cone crusher). Furthermore, since the loading force being placed on the rollers in use is likely to be about an order of magnitude lower than the loading force required in a conventional design of roller crusher apparatus, then the use of hardened rollers (that is, having an extremely hard exterior coating material) can also further lengthen the life of the present apparatus by about an order of magnitude.

In some alternative embodiments, the entire body of the rollers is made of hardened materials.

In some embodiments, the crushing machine is operable in use to crush a predetermined flowrate of solid particulate material therethrough.

When the machine is operated so that only those particles which are larger than the predetermined lateral distance are broken, and each breakage event represents a single-particle breakage and not bed breakage, this makes such a stage-wise crushing device intrinsically energy-efficient. The predetermined lateral distances between roller pairs are arranged to provide just sufficient compression to the top-size feed particles to result in particle breakage, and to necessitate a minimum viable normal compressive load on the rollers, in contrast to other known rollers crushers that are designed to operate at high normal compressive loads on the rollers. By using a correctly calibrated predetermined lateral distance in each crushing stage, and by slowly feeding the solid particulate material to the machine, (for example, as a mono-layer), a continuous feed stream can be achieved through the crushing machine, using elongate crushing rollers.

The control of particle breakage in the apparatus of the present disclosure operates in contrast to known prior art crushing apparatus in which there is little or no control over which particles are broken, and for which bed-breakage is the norm, leading to over-grinding of a large portion of the material, to a size which is below the minimum product size needed (for example, for mineral liberation from an ore) and considerable energy wastage. Furthermore, because of such particle size control, there is potentially less need for post-equipment classification devices to be associated with the crushing machine, in order to recycle certain particulates back upstream for further breakage, thereby saving further energy costs. The apparatus of the present disclosure can therefore achieve substantial savings in energy usage while applying the minimum required degree of breakage for effective mineral liberation.

In a second aspect, embodiments are disclosed of a roller crushing machine for progressively crushing solid particulate material into finer size particulates, the machine comprising:
a plurality of spaced-apart crushing stages arranged so that, during use, a flow path of said particulates travels consecutively from one crushing stage to the next;
each crushing stage comprising a pair of rollers, each mounted for rotational motion about an elongate axis, each roller of said pair along with its respective drive transmission mechanism representing a functional unit which is located at a support; and
respective outer peripheral surfaces of the rollers in a crushing stage being adjustably displaceably set apart from each other by a predetermined lateral distance not greater than a desired maximum particulate size from that crushing stage, said lateral distance being in alignment with the flow path and perpendicular to the flow direction of solid particulate material which is received in use onto, and drawn between, the pair of rollers;
wherein, when progressing consecutively through the crushing stages:
   the predetermined lateral distance encountered by the flow path is adjustable to be the same as, or smaller than, the predetermined lateral distance in any preceding crushing stage;
   the adjustment of the relative displacement of at least one of the following components of a crushing stage in relation to that crushing stage: a functional unit, a component which is operably connected to the roller of a functional unit; or a roller is arranged to provide an operable precision of adjustment of the predetermined lateral distance between the roller pairs to within 20% thereof; and
   the rollers in said crushing stages are operable with a rate of rotational motion which is the same as, or faster than that of the rollers located in any preceding crushing stage.

In some embodiments, adjustment of the relative displacement of said functional units is arranged to provide an operable precision of adjustment of the predetermined lateral distance between the roller pairs to within 10% thereof.

In some embodiments, the features of the roller crushing machine of the second aspect, may be otherwise as disclosed for the first aspect.

A high degree of precision makes it possible to maintain even a very small predetermined lateral distance, such that the rollers remain parallel. The required degree of precision will increase for each successive crushing stage as the distance between the rollers becomes smaller.

In a third aspect, embodiments are disclosed of a roller crushing machine for progressively crushing solid particulate material into finer size particulates, the machine comprising:
a plurality of spaced-apart crushing stages arranged so that, during use, a flow path of said particulates travels consecutively from one crushing stage to the next;
each crushing stage comprising a pair of rollers, each mounted for rotational motion about an elongate axis, each roller of said pair along with its respective drive transmission mechanism representing a functional unit which is located at a support; and
respective outer peripheral surfaces of the rollers in a crushing stage being adjustably displaceably set apart from each other by a predetermined lateral distance not greater than a desired maximum particulate size from that crushing stage, said lateral distance being in alignment with the flow path and perpendicular to the flow direction of solid particulate material which is received in use onto, and drawn between, the pair of rollers;
wherein when progressing consecutively through the crushing stages:
   the predetermined lateral distance encountered by the flow path is adjustable to be the same as, or smaller than, the predetermined lateral distance in any preceding crushing stage;
   each roller in the pair of rollers in any one of said crushing stages is operable with a tangential velocity within 5% of the respective other roller; and
   the roller pairs in said crushing stages are arranged to be operable with a rate of rotational motion which is the same as, or faster than that of the rollers located in any preceding crushing stage.

In some embodiments, each roller in the pair of rollers in any one of said crushing stages is operable with a tangential velocity within 2% of the respective other roller.

In some embodiments, the features of the roller crushing machine of the third aspect, may be otherwise as disclosed for the first aspect.

In a fourth aspect, embodiments are provided of a roller crushing machine for progressively crushing solid particulate material into finer size particulates, the machine comprising a plurality of spaced-apart crushing stages arranged so that, during use, a flow path of said particulates travels consecutively from one crushing stage to the next, each crushing stage comprising:
a pair of rollers, each mounted for rotational motion about an elongate axis, each roller of said pair along with its respective drive transmission mechanism representing a functional unit which is located at a support; and
respective outer peripheral surfaces of the rollers in each crushing stage being adjustably displaceably set apart from each other in use by a predetermined lateral distance which is in alignment with the flow path and perpendicular to the flow direction which is received in use onto, and drawn between, the pair of rollers;
wherein when progressing consecutively through the crushing stages:
the predetermined lateral distance encountered by the flow path is adjustable to be the same as, or smaller than, the predetermined lateral distance in any preceding crushing stage; and
the rollers in said crushing stages are operable with a tangential velocity which is the same as, or faster than that of the rollers located in any preceding crushing stage; and
wherein for a preselected solid particulate material being passed through the machine, said predetermined lateral distance in each crushing stage is arranged of a dimension which is sufficiently operably narrow to provide sufficient compression breakage of just the topsize of the particulates at that particular size range of preselected solid particulate material.

In some embodiments, said predetermined lateral distance in each crushing stage is arranged of a dimension which is sufficiently operably narrow to inhibit the formation of a bed of multiple particulates thereacross, at that particular size range of preselected solid particulate material.

In some embodiments, the features of the roller crushing machine of the fourth aspect, may be otherwise as disclosed for the first aspect.

In a fifth aspect, embodiment are disclosed of a comminution system for crushing solid particulate materials into finer size particulates, the system comprising:
a comminution machine in which a plurality of spaced-apart comminution stages are arranged so that, during use, a flow path of said particulates travels consecutively from one comminution stage to the next; and
each comminution stage including a pair of rollers mounted for rotational motion about an elongate axis, each roller of said pair along with its respective drive transmission mechanism representing a functional unit; and
respective outer peripheral surfaces of said rollers in a comminution stage are adjustably displaceably set apart from each other by a predetermined lateral distance not greater than a desired maximum particulate size from that comminution stage, said lateral distance being in alignment with the flow path and perpendicular to the flow direction of solid particulate material which is received in use onto, and drawn between, the pair of rollers;
said comminution stages being arranged so that, in use:
   the rate of rotational motion of the rollers in a comminution stage is adjusted such that the tangential velocity is the same as, or faster than that of the rollers located in a preceding comminution stage; and
   the predetermined lateral distance in a comminution stage is smaller than the predetermined lateral distance in a preceding comminution stage;
wherein the comminution system further comprises:
a sensing device which measures a physical parameter indicative of the energy being applied to operate the or each functional unit in a comminution stage; and
a controller which produces a signal to control at least one component of a functional unit in a comminution stage, to maintain the flow of particulates passing therethrough to a stipulated value, and/or to minimize overall energy consumption in said comminution stage.

In some embodiments, the at least one property of a functional unit in a comminution stage which is controllable in use to maintain the flow of particulates passing therethrough to a stipulated value, and/or to minimize overall energy consumption in said comminution stage, is from the group comprising:
the rate of rotational motion of the or each roller in a roller pair; and
width of the predetermined lateral distance between each roller in a roller pair.

In some embodiments, the rate of rotational motion of each roller of a functional unit in a comminution stage can be controlled, in use so as to inhibit the formation of a bed of multiple particulates thereacross at a particular size range of solid particulate material, and to maintain a mono-layer flow of particles passing therethrough, thereby minimizing energy consumption in that stage.

In some embodiments, the predetermined lateral distance between each roller of a functional unit in a comminution stage can be controlled to be of a dimension which is sufficiently operably narrow to just apply a sufficient compression breakage force to only the topsize of the particulates at that particular size range of preselected solid particulate material, but not their progeny, and in so doing, inhibiting the formation of a bed of multiple particulates thereacross, and maintaining a mono-layer flow of particles passing therethrough, and to thereby minimize energy consumption in that stage.

In some embodiments, the predetermined lateral distance encountered by the flow path is adjustable to be relatively smaller than the predetermined lateral distance in a preceding crushing stage by a preselected numerical ratio which is within the range of greater than 1 and less than 2.

In some embodiments, the physical parameter indicative of the energy being applied to operate the or each functional unit in a comminution stage in use is rotational torque, and the sensing device is a torque meter.

In some embodiments, the physical parameter indicative of the predetermined lateral distance between the roller pairs in a comminution stage in use is the displacement between the outer peripheral surface of the rollers components, and the sensing device is a distance measurement sensor.

In a sixth aspect, embodiments are disclosed of a comminution system for crushing solid particulate materials into finer size particulates, the system comprising:
a comminution machine in which a plurality of spaced-apart comminution stages are arranged so that, during use, a flow path of said particulates travels consecutively from one comminution stage to the next; and
each comminution stage including a pair of rollers mounted for rotational motion about an elongate axis, each roller of said pair along with its respective drive transmission mechanism representing a functional unit; and
respective outer peripheral surfaces of said rollers in a comminution stage are adjustably displaceably set apart from each other by a predetermined lateral distance not greater than a desired maximum particulate size from that comminution stage, said lateral distance being in alignment with the flow path and perpendicular to the flow direction of solid particulate material which is received in use onto, and drawn between, the pair of rollers;
said comminution stages being arranged so that, in use:
the rate of rotational motion of the rollers in a comminution stage is adjusted such that the tangential velocity is the same as, or faster than that of the rollers located in a preceding comminution stage; and
the predetermined lateral distance in a comminution stage is smaller than the predetermined lateral distance in a preceding comminution stage;
wherein the comminution system further comprises:
a sensing device which measures a physical parameter indicative of the energy being applied to operate the or each functional unit in a comminution stage; and
a controller which produces a signal to control at least one component of a functional unit in a comminution stage, to maintain the flow of particulates passing therethrough to a stipulated value, and/or to minimize overall energy consumption in said comminution stage.

In some embodiments, the at least one property of a functional unit in a comminution stage which is controllable in use to maintain the flow of particulates passing therethrough to a stipulated value, and/or to minimize overall energy consumption in said comminution stage, is from the group comprising:
the rate of rotational motion of the or each roller in a roller pair; and
width of the predetermined lateral distance between each roller in a roller pair.

In some embodiments, the rate of rotational motion of each roller of a functional unit in a comminution stage can be controlled, in use so as to inhibit the formation of a bed of multiple particulates thereacross at a particular size range of solid particulate material, and to maintain a mono-layer flow of particles passing therethrough, thereby minimizing energy consumption in that stage.

In some embodiments, the predetermined lateral distance between each roller of a functional unit in a comminution stage can be controlled to be of a dimension which is sufficiently operably narrow to just apply a sufficient compression breakage force to only the topsize of the particulates at that particular size range of preselected solid particulate material, but not their progeny, and in so doing, inhibiting the formation of a bed of multiple particulates thereacross, and maintaining a mono-layer flow of particles passing therethrough, and to thereby minimize energy consumption in that stage.

In some embodiments, the predetermined lateral distance encountered by the flow path is adjustable to be relatively smaller than the predetermined lateral distance in a preceding crushing stage by a preselected numerical ratio which is within the range of greater than 1 and less than 2.

In some embodiments, the physical parameter indicative of the energy being applied to operate the or each functional unit in a comminution stage in use is rotational torque, and the sensing device is a torque meter.

In some embodiments, the physical parameter indicative of the predetermined lateral distance between the roller pairs in a comminution stage in use is the displacement between the outer peripheral surface of the roller components, and the sensing device is a distance measurement sensor. In some embodiments, the comminution system further comprises the step of managing and maintaining the evenness of the flow properties of solid particulate materials, prior to feeding such materials into the comminution machine. In one form of this, the step of maintaining the evenness of the flow properties involves the use of bulk solids handling apparatus which handles issues to do with oversize materials, dampness, and pre-segregation of particulate materials.

In some embodiments, the comminution system further comprising using dust and fine particle extraction apparatus for separation of such products from multiple locations, during operation of the comminution machine. One exemplary form of this is the step of removal of at least some of the naturally-occurring fine particles by screening from the feed stream of solid particulate materials, prior to the remainder of the feed material entering the comminution machine.

In a seventh aspect, embodiments are disclosed of a method of crushing solid particulate material into finer size particulates, the method comprising the steps of:
causing the rollers of a plurality of pairs of rollers, to rotate about respective parallel elongate axes, and
supplying a solid particulate material successively through a gap between each pair of a plurality of pairs of laterally spaced-apart rotatable pairs of rollers, in which each pair defines a crushing stage,
said gaps between the rollers of each pair of rollers having been selected to crush a topsize only of the solid particulate material by contact of the topsize solid particulate material with the rotating surfaces of the rollers of the pair;
wherein the gap between the rollers of an upstream pair of rollers in the direction of movement of the solid particulate material is greater than the gap between the rollers of at least one successive downstream pair of rollers in the direction of movement of the solid particulate material, so that the solid particulate material is crushed into finer particulates when moving through the gaps between the rollers of the successive pairs of rollers.

In some embodiments, the method can comprise the step of selectively adjusting the gaps between pairs of rollers.

In some embodiments, the method can comprise the step of rotating the downstream pair of rollers at the same or faster rate than that of the upstream pair of rollers.

In some embodiments, the method can comprise selection of the numbers of pair of rollers and the sizes of the lateral gaps between the roller pairs so that less than 30% by weight of the solid particulate material passes through each pair of rollers at the topsize solid particulate material, thus giving a gradual, sequential grinding process.

In some embodiments of the aforesaid method, the solid particulate material is a mined ore.

In some embodiments of any of these aspects, the step of feeding a flow of particulate solid particulate material to be crushed or comminuted involves introducing a flow of particulate solids which is no more than necessary to form a mono-layer.

As already stated, throughout this specification, when the term “mono-layer” is used, it refers to an arrangement of a particular top-size of solid particulates which, in use, are fed into the pre-determined lateral distance between two rollers in a crushing stage, wherein that lateral distance is arranged so that sufficient compression occurs to effectively break the solid particulates which are greater in size than the lateral distance, and which pass through said lateral distance without inducing secondary breakage of the progeny—that is, no re-breakage of the broken fragments resulting from the initial breakage event (i.e. not bed breakage).

Aspects, features, and advantages of this disclosure will become apparent from the following detailed description when taken in conjunction with the accompanying drawings, which are a part of this disclosure and which illustrate, by way of example, principles of any inventions disclosed.

### DESCRIPTION OF THE FIGURES

The accompanying drawings facilitate an understanding of the various embodiments which will be described:

FIG. 1 is a side, schematic view of the roller crushing apparatus, illustrating the principle of operation of the crushing rollers—shown for a single crushing stage roller pair.

FIG. 2 shows the principle of operation illustrated for a sub-set of three stages of crushing rollers.

FIG. 3 shows a side view of a typical installation with a primary stack and a natural fines stack.

FIG. 4 illustrates a plan view of basic layout of the equipment

FIG. 5 illustrates a side view of a typical installation with a split primary stack

FIG. 6 illustrates a side view of typical installation with an off-set and split secondary stack.

FIG. 7 illustrates a plan side view of typical installation with an off-set and split secondary stack.

FIG. 8 illustrates a plan view of an installation with two primary stacks and two natural fines stacks.

FIG. 9 provides a detailed drawing of a projection view of a small 15-stage roller stack.

FIG. 10 provides a detailed drawing of a projection view of a single crushing stage module for a small 15-stage roller stack.

FIG. 11 is a photograph of the laboratory roller testing device.

FIG. 12 presents a graph of progressive product size distributions for a copper ore and photograph of samples of the products.

FIG. 13 presents a graph of progressive product size distributions for an iron ore and photograph of samples of the products.

FIG. 14 presents a graph of feed and product size distributions for seven ores that have been tested in the laboratory.

FIG. 15 presents a graph of product sizes for a Zinc ore compared to the product from production ball mill treating the same feed material.

FIG. 16 presents a graph of product sizes for a copper ore compared to the surveyed product from a production milling circuit treating the same feed material.

FIG. 17 is a photograph capturing single particle fracture in a laboratory compressive stress apparatus.

FIG. 18 presents a graph showing the results from single particle breakage tests.

FIG. 19 presents a graph showing a summary of the energy results from single particle breakage tests.

FIG. 20 presents a graph of the relationship between the number of crushing stages and the required overall size reduction for different reduction ratios.

FIG. 21 present a graph comparing the product sizes for the device and a SAG-ball mill circuit, with the associated size recovery zone.

Table 1 provides an example of a 23-stage roller stack configuration and principal operating parameters.

Table 2 presents calculation of the typical expected range of load along the device rolls.

Table 3 presents calculation of the typical expected range of load along HPGR rolls

### DETAILED DESCRIPTION

This disclosure relates to the features of a comminution machine for crushing particulate solids, for example primary-crushed mineral ore from a mine, which in use is normally gravity-fed into and out of the machine. The disclosure also relates to a method of operating and controlling the comminution machine to minimise the quantity of energy consumed whilst still achieving the necessary size reduction. As a result of its configuration, the machine can be operated to minimise overgrinding of the solid particulates when compared with other known apparatus in the field of comminution.

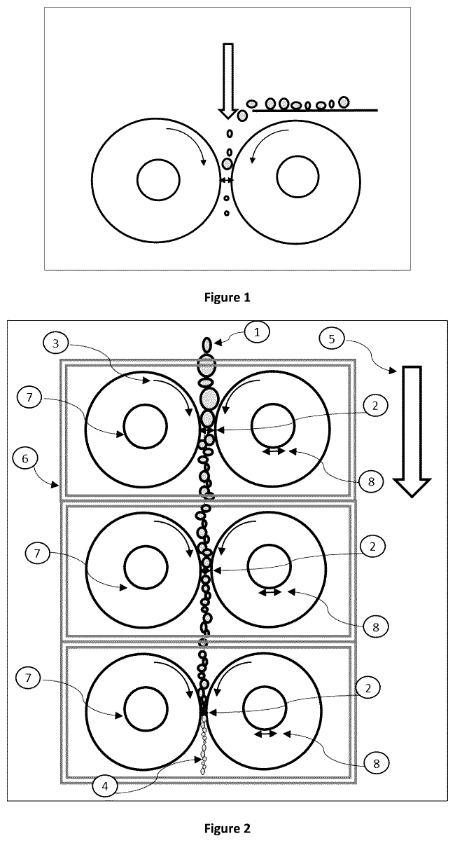

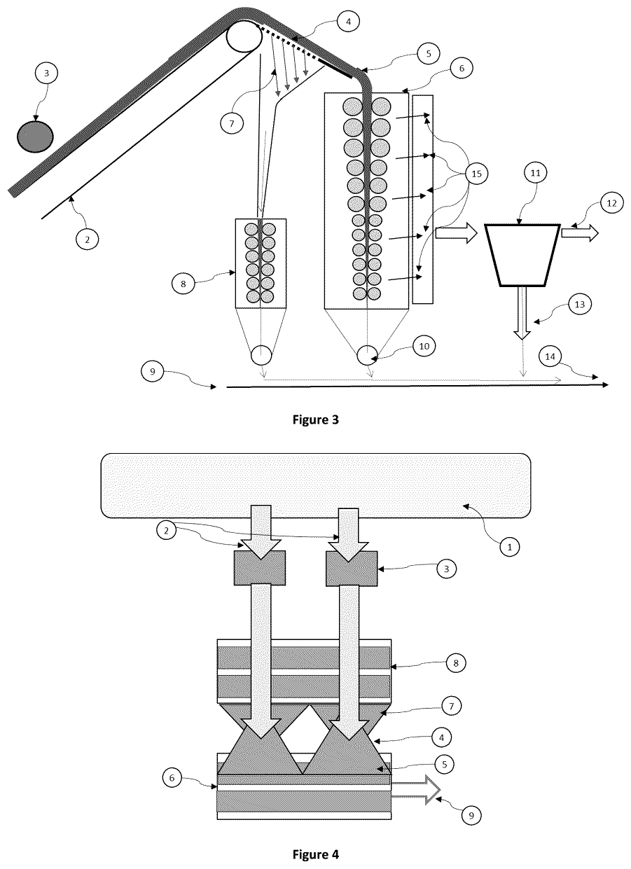

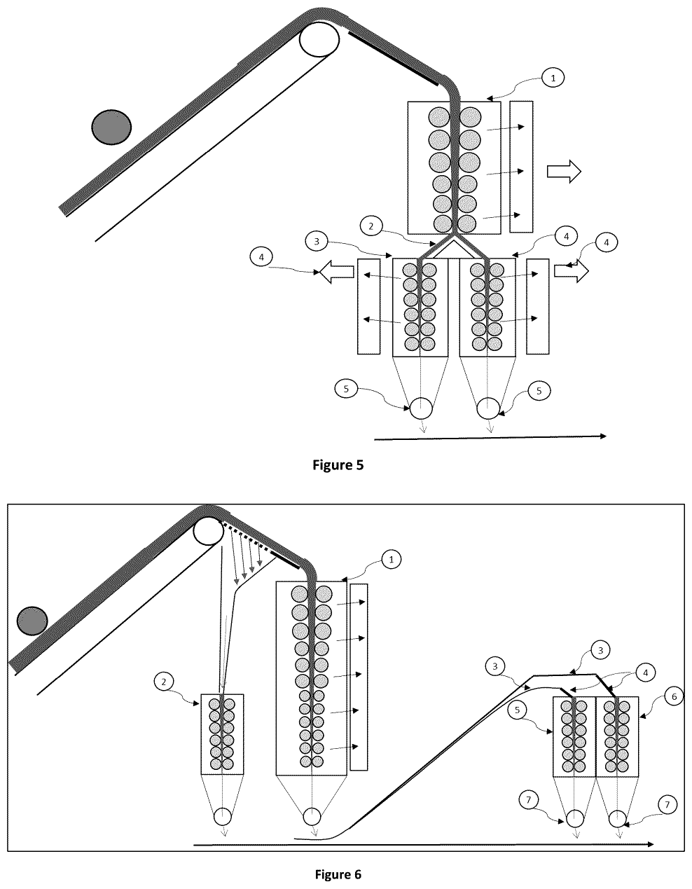

Referring to the drawings, the apparatus shown in FIG. 1 comprises a single stage of a multi-stage comminution machine, in the form of a roller crusher machine. In practice, a multi-stage roller crusher machine comprises a plurality of such comminution or crushing stages, each being located onto a support and which are arranged for the progressive comminution of solid particulate materials into finer size particulates. For example, in the embodiments shown in FIG. 3 and FIG. 5, the machines comprise a plurality of crushing stages, horizontally oriented and stacked above one another so that, in use, solid particulates travels consecutively downwardly from one stage to the next, until exiting the machine.

In the single stage of the biaxial roller crusher apparatus which is shown in FIG. 1, there is a pair of moveable comminution elements in the form of elongate rollers (shown in cross-section), each of which are mounted for continuous, repetitive rotational motion about their respective elongate axes. Each roller is of similar dimensions (width, length) to the other one of said pair.

There are many ways to cause the rotational motion of the rollers. In one form, each roller is connected to a respective drive transmission mechanism to enable the roller to rotate about its own elongate axis, and each drive transmission mechanism is, in turn, connected in use to a motor drive to provide the energy for rotation, as will shortly be described. The drive transmission mechanisms and the rollers are mounted on a support in the form of an open frame structure, or at a wall of a cabinet, or at some other type of machine housing or structure.

In the single crushing stage shown in FIG. 1, each of the elongate rollers is fitted with a torque sensor to enable measurement of the energy needed for the roller to be rotated about its own elongate axis. Prior to initiation of the machine, the outer peripheral surfaces of the pair of rollers are set apart from each other by a predetermined lateral distance, which is first determined by the machine operator considering the solid particulate material to be crushed, the number of crushing stages and other physical factors. During use of the machine, the predetermined lateral distance in each crushing stage can be monitored, usually by means of a laser distance sensor. That predetermined lateral distance (or “roller gap”) becomes the maximum particulate size of crushed particulate which will result from that comminution stage, if the solid particulate material to be crushed is fed as a monolayer thereinto.

In the multi-stage roller crushing machine shown in FIG. 2, the pre-determined lateral distance (“roller gap”) between roller pairs in consecutive stacked crushing stages is vertically in alignment with the flow path of solid particulate material which is received in use onto, and drawn between, the roller pairs, as shown by flow stream which represents the path of particulates falling under the influence of gravity. In further embodiments of the multi-stage machine, the roller gaps within a stack can be misaligned, but in such cases a chute or duct or similar static or vibratory device can be used to guide the flow of solid particulates exiting from the uppermost crushing stage, and onto the region above the rollers in the next consecutive crushing stage.

Importantly, the outer peripheral surfaces of the pair of rollers in each crushing stage are able to be set apart from each other by a predetermined lateral distance, first determined by the machine operator, prior to initiation of the crushing operation. The predetermined lateral distance is adjustably displaceable so that the operator can decide whether it will be the same as, or smaller than, the predetermined lateral distance in the preceding stage(s) wherein when progressing consecutively through the stack. In some cases, there may be very small or gradual reductions in the roller gap, for very hard to crush solid particulate materials, and all crushing stages will be required to minimise instances of bed breakage/secondary crushing. In other situations, the solids may fracture very easily from the initial primary-crushed feed size to reach the target size range, so some of the lower crushing stages may not even need to be used.

### Description of Apparatus for Operating the Disclosed Method

This section provides an overall description and a more detailed set of features required for a multi-stage roller crushing device to meet the requirements of the disclosed method. Alternative configurations may be possible.

The essential features of such a multi-stage roller stack device are disclosed as follows:

The device normally comprises at least six sequential stages of horizontally opposed roller pairs, with each pair rotating at the identical circumferential speed (but different from other pairs) and supported by an appropriate bearing, bearing housing system and a rigid framework.
FIG. 1 shows a schematic of the top pair with the feed entering off the feeder as a monolayer 1, passing though the gap 2 of the counter-rotating rolls 3 to produce a product 4.
·FIG. 2 illustrates the particle flow and rolls mounting principle for a subset of 3 stages of rolls within the full stack of rolls. This shows the direction of flow 5, the rigid mounting frames 6, the fixed rolls bearing 7 and movable rolls bearing 8 for each stage.
Most applications will require in excess of 12 such stages.
Each roller crushing stage must be located in close proximity to the preceding stage such that the rollers of each stage are parallel to, or approximately parallel to, the preceding stage and located such that the distance that the particle stream must travel from one stage to the next is minimised. Provided that these requirements are met, the crushing stages can be arranged as independent modules or located in an external frame, or a combination of such arrangements may be employed.
Each crushing stage should be encapsulated by covers than prevent the egress of dust or the disturbance of the mono-layer by external air currents or other factors.

The comminution machine shown in side elevation in FIG. 3 (and with plan view of operational layout in FIG. 4) can perform crushing and size separation of solid particulates such as a run-of-mine feed ore which has been pre-crushed to <80 mm nominal top-size by a primary crusher. The ore is conveyed on a conveyer and then passed over a vibrating screen separator and distributor device, to produce an underflow of <3 mm natural fines, and an overflow which comprises the major coarse component of the ore solids. The two flow streams of ore are then each passed through separate stacks of roller crushing stages. As shown in FIG. 5, the main stack is arranged to crush the −80 mm-3 mm solid particulate material by passing it through 12 separate roller crushing stages, which actually comprises a primary stack of 6 stages, with the underflow from the primary stack then being fed to the top of two secondary stacks, which are operated in parallel, and each comprising 6 roller crushing stages.

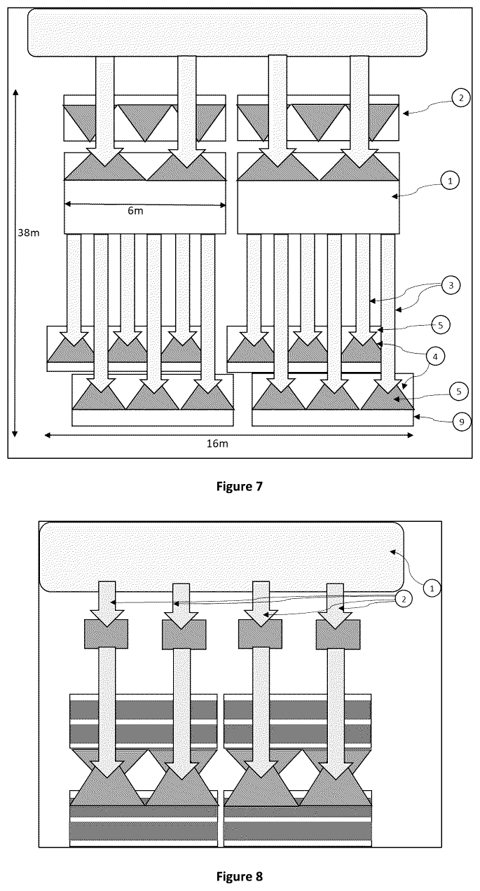

The reason for the twin parallel secondary stacks is to maintain a certain throughput of solids material. If the same amount of solids material by weight is to be passed continuously through the machine, but the narrowing roller crusher gap (to effect particle size reduction) results in a diminishing cross-sectional area between crusher roller pairs which are in the latter grinding stages, then for the same tonnage of (finer) solid particulates to be able to flow through the machine, the cross-sectional area will need to be increased. In the embodiment shown in FIG. 6 and FIG. 7, a system of interlaced conveyers splits the product from the primary stack of crushing stages into two flows, one for each of the parallel secondary crushing stacks which have smaller roller diameters along with smaller predetermined lateral distances between those rollers pairs (progressively smaller size “roller gaps”). The inventor's calculations show that a machine of this type (i.e. two flows in parallel secondary crushing stacks) can handle a solids throughput of 2000 tonnes per hour, whilst performing a size reduction from <80 mm top-size down to <200 μm (or <0.2 mm) in just 23 roller crushing stages.

The use of 12 roller crushing stages in FIGS. 3 and 5 is for illustrative purposes only, and any number of crushing stages and roller pairs can be used, although the principle of the layout will remain the same. The mentioned solid particulate material feed rate is also illustrative, and greater or lesser quantities are contemplated, depending on the specific nature of the solids to be crushed. The use of two parallel secondary stacks is also illustrative for the throughput of this example, and there could be a greater number of secondary stacks, depending on factors such as the required fineness of the grinding size of the particles, solids hardness, bulk density, etc.

In yet other embodiments, the method of splitting the feed into the primary stack and natural fines, followed by the step of crushing using a primary and one or more secondary stacks linked together may be varied with design iterations. For example, there may be no need for a plurality of secondary stacks. On the other hand, available working height space may be a restriction, in which case there may be a primary stack followed by one or more secondary stacks as well as one or more tertiary stacks of crushing stages.

The machine shown in FIG. 2 comprises a fixed frame support such as a cabinet which ultimately provides the support for the location and operation of the pairs of rollers, as well as their respective drive transmissions which effect rotation of the rollers. Each crushing stage features adjacent, horizontally co-planar, biaxial roller pairs in which each roller of the pair is a dimensional twin of the other in terms of diameter and length. The pairs are arranged in a stack descending from the top of the fixed frame. As shown in FIG. 3, the first three crushing stages (uppermost stages) have pairs of rollers which are dimensionally the same. In the next three consecutive stages of the stack (middle level stages) the pairs of rollers have a diameter which is smaller than the roller diameter in the first three crushing stages which immediately preceded it. This same pattern continues through all 12 stages of the crushing machine.

Other arrangements are possible in other embodiments, for example each roller pair smaller than the immediately preceding roller pair, which may be beneficial depending on the solids type and the other factors, but of course, for the illustrative example presented, this means that the machine operator will need to keep 12 different roller diameter sizes as spare parts.

It is expected that, in practice, the crushing rollers are likely to be in the range of 4 to 6 metres in length, but this is exemplary only, and may be varied to suit the application. It is also expected that, for those embodiments where the roller diameter progressively decreases through the various crushing stages in the stack, an exemplary roller diameter in the first few crushing stages is about 2 metres, and an exemplary roller diameter in the final few crushing stages is about 0.3 metres, which of course may be varied to suit the application.

The rollers in each pair both have round, cylindrical, outer peripheral surfaces which are in alignment with a centre axis of the roller. As shown in the drawings, cach of the rollers in each pair are spatially arranged to be co-axial and horizontally co-planar, although of course other arrangements are possible, such as rollers which are horizontally offset. In use, each roller of the pair in each stage is respectively supported to be freely rotating in mutually opposite directions toward the roller gap which is located between the roller outer peripheral surfaces, and into which the solid particulate material is drawn and crushed between the rollers.

As described earlier for the embodiment shown in FIG. 3, the diameter of the rollers in the sequential crushing stages progressively decreases when moving through the stack of crushing stages. There can also be other embodiments in which the diameter of the rollers in the sequential crushing stages is essentially the same when moving through the stack of crushing stages. However, in all embodiments, what has been found is that it is the circumferential (or tangential) velocity of the rollers which helps to pass the same amount of feed ore material through a steadily smaller lateral distance (or “flow path gap”, or “roller gap” width) between each roller pair. That is, when proceeding sequentially down a vertically arranged stack of crushing stages (or indeed sequentially through a stack of crushing stages which have another orientation) until the crushed material exits the machine, an increase in the roller tangential velocity facilitates an even distribution (or spreading) of the particulate material (or mono-layer) over the roller pair in each crushing stage

The rate of rotational motion of the roller(s) is imparted by a motor delivering an angular velocity of rotation of the roller about its elongate axis. Therefore, in an example machine such as the layout shown in FIG. 3 which uses progressively smaller diameter rollers, a progressive increase in the tangential velocity of the roller pairs can be achieved merely by operating all of the rollers with at least the same angular velocity, although in practice when moving through the stack of crushing stages a higher angular velocity is more likely to be used, by increasing the speed of the motor drive and of the drive transmission mechanism in the later crushing stages.

However, in an example machine which uses essentially the same diameter of rollers throughout, a progressive increase in the tangential velocity of the roller pairs can only be achieved by operating the rollers with an increased angular velocity when moving through the crushing stages, typically by increasing the speed of the motor drive and of the drive transmission mechanism over the crushing stages.

In order to commence operation of the comminution machine an operator will make an initial adjustment to set the predetermined lateral distance between rollers in each of the crushing stages, typically decreasing in a progressive manner from stage to stage, or at least with step-wise decreases at various point in the stack. The predetermined lateral distance is determined when a sufficient degree of compression to the top-size of those particulates entering that stage can effectively break them just one time, and yield a desired maximum particulate size from that crushing stage. This can be established by prior test work, as will be discussed in more detail later in this specification.

With the aim of maintaining a mono-layer of material for crushing between the roller pairs, in most cases the operator will need to set the adjustable rate of motion of the rollers to be at least the same as, or to generally progressively increase to a faster speed over the various crushing stages in the stack. Mono-layer control is achievable by controlling roller tangential speed, rather than the roller gap width.

When these steps are accomplished, and the roller motors are activated across the crushing stages, a flow of particulate solids material can slowly be fed via a vibratory feeder or chute into a first crushing stage, where the particulates are spread onto the uppermost pair of rollers.

The round end faces of each cylindrical roller have a short shaft projection thereat, circular in cross-section and in alignment with the centre point of said end faces, and therefore with the centre axis of rotation of the roller. Each of those end shaft projections are mountable at a bearing housing, which is itself mountable in a cavity or recess part of the drive transmission mechanism, and the or each end shaft projection(s) is operatively connected to the remainder of the drive transmission mechanism. The roller, its end bearing housings and its drive transmission mechanism when coupled together form a functional unit in use. In use, the bearings facilitate axial rotation of a cylindrical roller about its centre axis along with its drive transmission mechanism, in response to turning of a motor drive.

Once there is an operative connection established between the or each end shaft projection of the rollers and the drive transmission mechanism for that roller, in order to actuate the axial rotation of the roller, an operative connection is required with a motor drive. There are a number of ways to accomplish this. The two drive transmission mechanisms in one crushing stage can be connected to a single motor drive via a common drive train, and there may be a gearbox to regulate the rotation of one or both rollers, to enable operation at either the same rate of rotational motion, or at a differential rate of rotational motion. In another arrangement, the two drive transmission mechanisms found in a plurality of crushing stages can be connected to a single motor drive via a common drive train. In another arrangement, as seen in the embodiment shown in FIG. 4, each roller drive transmission mechanism, in all crushing stages, is separately connected to an independent, direct drive motor, that is, one motor for each roller.

The functional units (each roller of said pair and its respective drive transmission mechanism) are located at the support frame, to rotatably support the rollers thereat. In a crushing stage, at least one of these two functional units is displaceable relative to the other, to allow independent operator adjustment and setting of said predetermined lateral distance;

For example, to compensate for the wearing down of the rollers, or to set the roller gap between two rollers, the crushing machine can cause the movement of the axis of one roller in a lateral direction, so as to become closer to the axis of the other parallel roller in the pair (for example, by adjusting the position of the combined roller and drive assembly).

One roller and its roller drive transmission mechanism shown in FIG. 4 is displaceable in a lateral direction toward or away from the respective other functional unit. The displacement is accomplished by use of an hydraulic piston which is mounted to both the functional unit and to the machine support frame, and is operatively connected to the control system and, when deployed, can slide the functional units apart.

In other embodiments, this functionality can also be achieved by using a pivoting set of arms to mount each of the functional units to the machine support frame. These arms can be set to a fixed distance apart with a hydraulic retainer to hold them in place. Alternatively, each roller mounting can have independent hydraulic retainers linked to a common hydraulic system.

In the crushing machines for which a hydraulic mechanism is used, the hydraulic fluid can be rapidly dumped, in case of an overload on any set of rollers. For example, it is also desirable that the rollers can be rapidly released to open up the roller gap if an unbreakable object, such as a steel piece, enters the system.

In further embodiments of comminution machine, in any single stage the pair of comminution elements can be in other forms which are mounted with one or both elements capable of continuous repetitive motion about a respective axis, for example, opposing jaw crusher plates, at least one of which can be repeatedly moved towards and away from one other jaw plate, for example in a swinging motion about a respective pivot axis. In such an example, the or each jaw crusher plate can be connected to its respective drive transmission mechanism (for example, via a toggle plate) to enable it to repeatedly pivot and thus to open and close the gap between the plates to crush and release solid particulate materials passing therebetween.

Physical features of the novel equipment disclosed herein, and its operating infrastructure can include:

### Operational Control System

A PLC-control system is used to manage roller rotational speed, and predetermined distance between roller pairs by taking feedback inputs from sensors which measure roller torque, roller load, roller surface condition, spaced-apart distance of the two rollers in pairs, etc.
The PLC-control system can continuously monitor and then cause adjustment/regulation of the pre-determined lateral distance between roller surfaces (i.e. roller gap), for example. Changing the proximity of rollers in a roller pair can be achieved by actuation of the lateral movement of one or both rollers (and its respective roller drive transmission mechanism) which can be automatic, as well as with a manual over-ride.
The PLC-control system can also continuously monitor and then cause adjustment/regulation of the rotational speed of the rollers, as well as to regulate the rate of input of solid particulates for crushing, as necessary (for example by control of the rate and vibration of the vibratory feeder unit). The function of the PLC-control system is to maintain a monolayer of feed solids particulates on the roller pairs whilst also maximising throughput capacity of solids materials being crushed in the machine.
The PLC-control system can also monitor and control the temperature of the roller-bearings in the drive assembly housings, as well as automatically re-lubricate the roller-bearings in the drive assemblies.

### General Machine Construction

Modular construction of the machine allows any required number of crushing stages to be added in a single stack, or multiple stages can be stacked, and those stacks can be located side-by-side and connected via bottom to top solids conveyer systems, so that the equipment does not become prohibitively tall. In any event, the stack(s) represent a more efficient use of limited floor space when compared with conventional crusher technologies;
The machine provides easy side access via the side walls to the rollers themselves, to facilitate roller change-out and replacement;
The machine has a dust-tight enclosure for the stacks of roller pairs/crushing stages, and also has one or more aspiration/gas extraction connections for de-dusting of the inside of the crusher chamber, to remove airborne dust and fines. The connections can be located at strategic points about the equipment to provide both dust suppression and to remove the fine final product as it is produced (nominally minus 250 μm but dependent on the application).

### Solid Particulate Feed Input

Solid particulates are fed into the machine by way of a vibratory dosing chute or vibratory roller feeder or spreader.

### Rollers

Rollers can have different material qualities such as hardness and durability, adapted as required for whatever product the machine is designed to crush, perhaps even including various roller surface corrugation forms and sizes; and
Assessment of wear-and-tear at the roller surfaces is done during use by laser detector measurement. Then to compensate for the wearing down of the rollers, the crushing machine can cause the movement of the axis of one roller in a lateral direction, so as to become closer to the axis of the other parallel roller in the pair (for example, by adjusting the position of the combined roller and drive assembly).

### Experimental Section

### Experimental Validation—Equipment

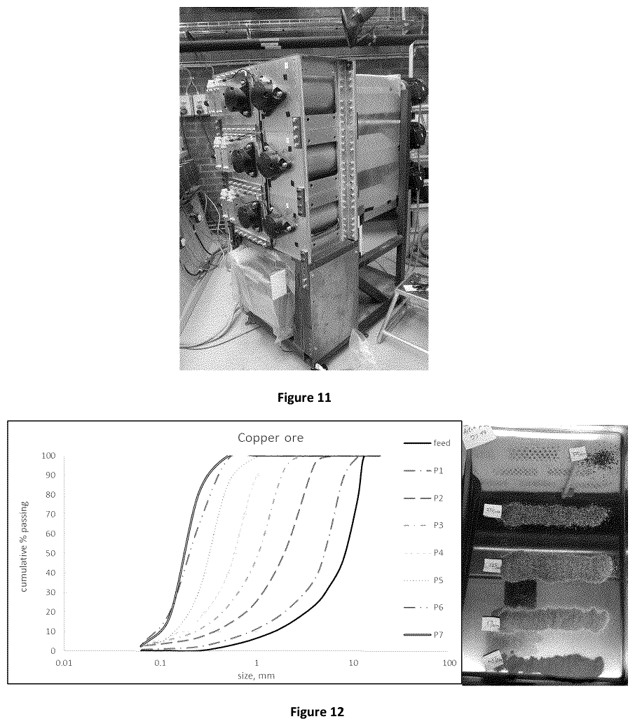

A laboratory scale version of the crushing machine has been constructed as shown in FIG. 11. The machine operates with a reduced set of just three rollers, and so in order to produce results over a 12-stage crushing process, the exemplary solid particulate material being crushed was fed through this machine in multiple passes. After each pass-through, the pre-determined lateral distance between the respective roller pairs was then reduced to match the pre-determined lateral distances required to be used if all 12 crushing stages were arranged in a continuous vertical stack.

### Throughput Calculations:

The throughput and energy calculations are provided in Table 1. This gives the solids throughput for rollers of the stated diameter, length and speed. Two stacks are allowed for, to minimise vertical height and to allow for the feed to be distributed to more sets of rollers at the finer end of the particle size range.

The following parameters are measureable:

Throughput=roller tangential speed×feed bulk density

Roller tangential speed=Roller diameter×π×revolutions per second
Feed bulk density is calculated as the solid particulate stream enters each crushing stage at the roller gap;
Feed bulk density for a given volume=mass of all particles in a given volume/the given volume.

These parameters can be experimentally measured for a range of feed solid particulates (e.g. mineral ores) and operating conditions. This data provides the details of the input energy and resultant progeny for provision of just a sufficient amount of energy to break a particle. The energy used is a strong function of particulate size, and rapidly increases as the required size decreases. This is accounted for in the progressive size reduction calculations given here.

Energy use per set of rollers=mass flow (tonnes/hr)×fraction of feed larger than pre-determined lateral distance×specific energy to fracture (kWh/t).

### Experimental Data

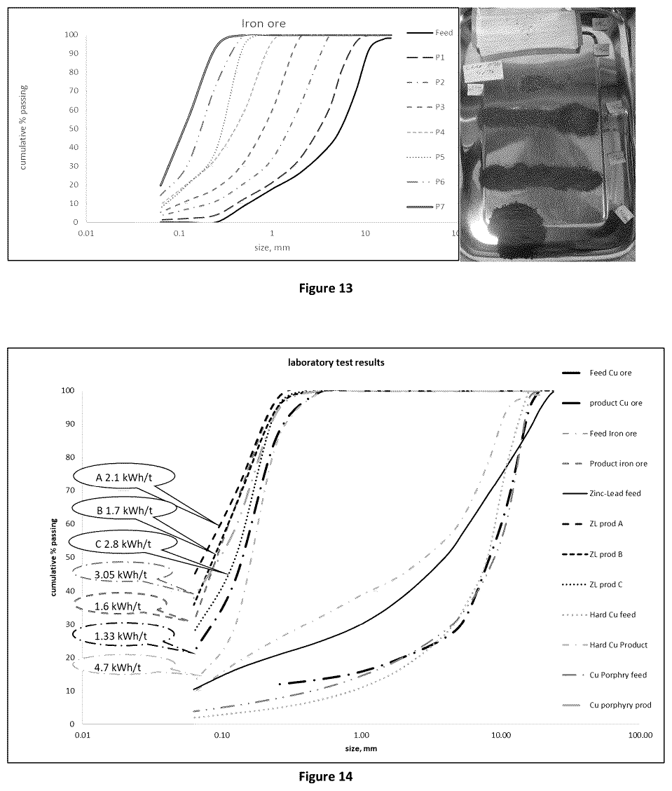

A number of ores have been tested in the in the laboratory rig. The results are illustrated as a progressive size distribution after each pass of three rollers, with a photograph of the final product alongside it. FIG. 12 shows the results for a copper ore, and FIG. 13 shows the results achieved for an iron ore.

In summary these results illustrate the viability of the equipment, and also that the proposed narrow product sizes are possible to achieve. The overlap of pass 5 with pass 4 is due to the step of removal of final product (˜250 μm) from the feed after pass 4.

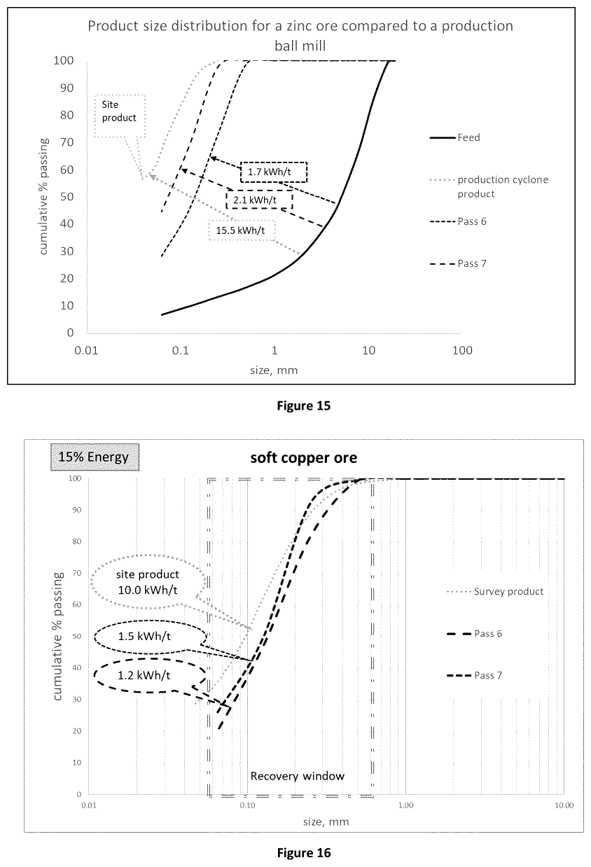

Energy consumption figures are provided in kWh per tonne of solids material which was crushed to the final product size. For a zinc mineral ore that usually requires 15.5 kWh/t in production, the energy use was 2.2 kWh/t to achieve a product size of P80 (80 percent of the product passing the given size)=95 μm, or 1.8 kWh/t to reach a P80=170 μm. FIG. 15 provides a comparison of the novel roller-mill product size achieved with prior art results known from a conventional crushing machine for the same Zinc ore, when starting from the same feed size distribution. In terms of required final product size, the energy fraction to achieve the top-size of the milled product is in the range of 11.6% to 14% of the requirement in typical production mills for this same ore, starting from the same mill feed size distribution.

### CONCLUSION

Details of a comminution technology, incorporating novel innovations, has been presented. The technology addresses the issue of overgrinding of solid particulate materials during crushing, and the net result of this improvement is a commensurate reduction in the amount of energy consumed. The comminution machine disclosed herein has many advantages over conventional crushing machine technologies:
It can handle a feed material of large size particulates, and provides the basis for a gradual, stage-wise reduction in particulate size. For example, it can take sub-80 mm top size primary crushed ore down to a final product size of minus 100 μm (0.1 mm) and a narrow particle size spectrum in a single continuous machine;
It has crushing stages that are arranged to provide a sufficient degree of compression to the particulates to effectively break them just one time, but not to induce secondary breakage (i.e. does not apply a large amount of energy in a single impact across a bed of particles). This makes such a stage-wise crushing device intrinsically energy-efficient. By feeding a mono-layer of particulates, only the particles that are larger than the gap size are broken and each breakage event is single particle breakage, not bed breakage.
When the machine is arranged to provide the aforementioned control of particle breakage, it avoids over-grinding of a large portion of the material, to a size which is below the minimum product size needed (for example, for mineral liberation from an ore). This feature can also minimise (but perhaps not eliminate) the requirement for an air classifier to remove ultrafine particulates as they are produced during overgrinding.
When the machine is arranged to have good control of particle breakage, it also means that there is potentially less need for post-equipment classification devices to be associated with the crushing machine, in order to recycle coarse unbroken particulates back upstream for further breakage, which in turn provides further energy cost savings.
In a machine which minimises particle breakage, the normal compressive load on the rollers is minimised, thereby limiting their wear and potential for breakage.
It can therefore achieve substantial reductions in energy usage. The inventor projects that the novel machine can use less than 20% of the energy of conventional production crushing and milling equipment when reducing sub-80 mm top size primary crushed ore down to a final product size of minus 100 μm (0.1 mm) in a single continuous machine.

The disclosed method and equipment therefore differ fundamentally from existing comminution equipment in that it achieves a large overall size reduction to a fine final particle size of around 100 μm through a controlled sequence of stages in which close to the minimum breakage energy is applied at each stage. This method minimizes the total energy consumed per tonne of product, guarantees a maximum final particle top size and minimizes the production of ultra-fine material. Experiments have confirmed theoretical predictions that the proposed method can achieve energy consumption in the order of 15-20% of conventional comminution equipment and deliver improved size distributions (FIG. 15 and FIG. 16). The proposed method and equipment has application in any process where a hard material must be reduced to a fine particle size with minimal energy expenditure.

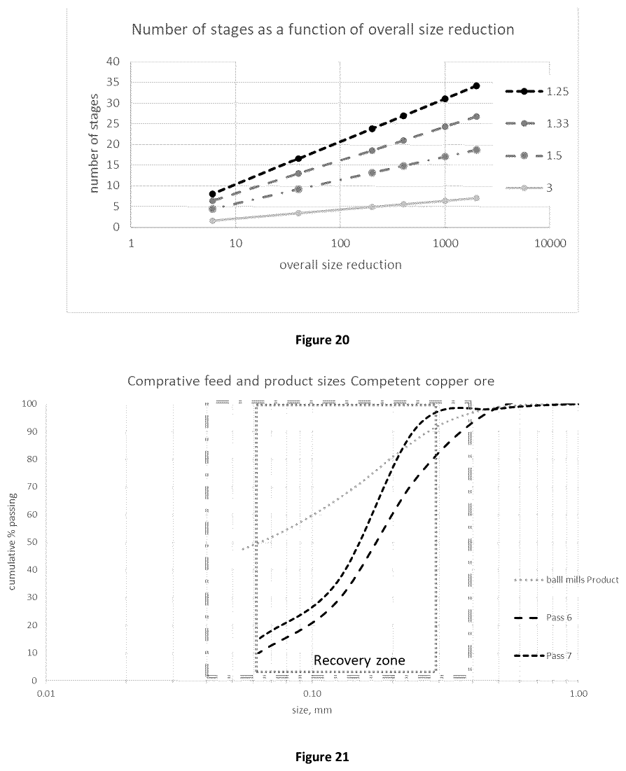

Due to the inverse relationship between the reduction ratio and the number of roller stages required, the use of such low reduction ratios automatically requires the use of more crushing stages than found in any prior art device for the same overall size reduction (defined as the difference in size between the largest feed particles and the largest product particles). Typical prior art roller crushers consist of 1-5 roller stages, whereas this method would optimally use over 20 crushing stages for a typical size reduction from 80 mm to 200 μm (see example in Table 1). There is thus a direct trade-off between the applied reduction ratio and number of stages, which impacts the financial viability of the equipment, requiring a design that balances energy efficiency through low reduction ratios and the cost of having more stages of crushing. The relationship is illustrated in FIG. 20, showing how the choice of reduction ratio can change the number of stages of rolls from 17 to 34 for an overall size reduction of 1000 when varying the reduction ratio from 1.5 to 1.25.

Additionally, the gap for each set of rolls must be set and controlled within tight limits so as to provide the required degree of reduction. For example, for a smaller gap than desired, a 20% relative error increases the reduction ratio from a favourable 1.25 to outside the desired operating range at 1.5. A 10% relative error would shift the reduction ratio to 1.38, just within the upper limits of the required efficiency, while a 5% relative error keeps the reduction ratio at 1.31, which is within the desired range of efficient operation. Whereas, if the error results in a wider gap a 20% relative error would result in a reduction ratio of 1 (i.e. no crushing) for a setting of 1.25. Furthermore an error in one stage knocks on to the next stage, resulting in a concomitant increase or decrease in reduction ratio of the next stage. Thus, a reduction ratio of 1 in a stage will result in an unfavourable reduction ratio of 1.56 in the following stage (if it has no error in gap setting). Based on this type of analysis, it is concluded that a relative error of 20% is the absolute maximum acceptable, with an error within 5% being highly desirable.

Multi-stage, minimum reduction, single particle crushing performed in this manner transfers the minimum normal compressive load to the rollers. This is in contrast to other known rollers crushers that are designed to operate at high normal compressive loads on the rollers. The precise load on each roller is a function of the material being crushed, the particle top size, the reduction ratio and the number of particles that are being compressed at any one moment. FIG. 18 and FIG. 19 present experimental data illustrating the magnitude of the force and energy required for each particle fracture event. These numbers are up to two orders of magnitude lower than required in a bed breakage regime, as shown in the calculations of Table 2 and Table 3. The lower force regime provides several benefits which are unique to the disclosed method. Each roller stage may be designed to apply lower forces and, since the fracture mechanism is primarily compressive, there is minimal abrasive action, which reduces wear rates on the rollers. Lower forces enable longer rollers to be used without such rollers experiencing excessive deflection. Taken together, these benefits enable the disclosed device to economically achieve higher throughput rates than would be expected from general considerations or simple calculations and to use more crushing stages than was previously believed to be economic.

By maintaining the correct feed rate into the device, the correct roller speeds and the correct lateral distance between rollers in each crushing stage, a continuous, mono-layer particle stream can be achieved through the crushing machine. The control of particle breakage in this manner operates in contrast to known prior art crushing apparatus in which there is little or no control over which particles are broken, and for which bed-breakage is the norm. This in turn leads to the disclosed device achieving energy reductions in the order of 80%, producing a very precise, directly controllable final product top-size and generating a noticeably lower portion of fine particles below the minimum product size needed (for example, for mineral liberation from an ore). Furthermore, because of such particle size control, there is potentially less need for post-equipment classification devices to be associated with the crushing machine, thereby saving further energy and capital costs.
The mechanisms used must permit a high degree of precision, and once set, it should be possible to maintain the gap with the same degree of precision such that the rollers remain parallel. The required degree of precision will increase for each successive crushing stage. In practice this can be achieved with the rollers mounted on a slide or a pivot system, although manual gap adjustment, for example by means of a threaded device, may also be satisfactory. An actuator-driven adjustment as a part of a control system is desirable as it enables adjustment and optimisation of each gap in real time. A suitable sensor to precisely measure the gap at, for example, each end of the roller, may be used to provide feedback to the gap adjustment mechanism.
Each roller pair should ideally (but not necessarily) be protected from overload conditions or from physical damage where foreign material has entered the machine. In one embodiment this consists of a gap release mechanism that is triggered when an excessive compressive force is detected in any roller pair and which mechanism then releases the rollers in all roller stages.
Each roller pair will be driven to achieve a particular circumferential velocity of each roller at each crushing stage which is consistent with the desired overall machine throughput, the reduction ratio between each crushing stage, the changes in the packing density of the particle stream as it progresses through the device, and the extent to which material is removed between stages (as dust or fine particle removal). In practice this calculation will set a range of speeds for operation of the rollers in each stage. An example of this calculation for a 23 stage device that achieves an overall size reduction from 80 mm to 200 μm is set out in Table 1.
The rollers may be driven in any manner that enables precise speed control within this range and which permits the transfer of the required power and torque to the rollers. This includes but is not limited to separate direct or geared motor drives for each roller, or a single drive unit for each stage.
The drive system must be capable of supplying the power to the rollers irrespective of the gap setting. In practice this can be achieved by the use of cardan shafts or by having the drive system for each roller move in parallel with the rollers. Other configurations are possible.
The roller diameters at each stage must be determined based on a number of factors. The combination of these factors and the economics of roller manufacture may result in the same or different diameter rollers being used at each crushing stage:
   The rollers must be designed to have sufficient rigidity to enable precise particle fracture across their length. This is more relevant in the latter stages of the device where a roller deflection of around 30 μm on a 100 μm roller gap represents a 30% potential error in the final product top size. The rigidity of the rollers is determined by the known engineering formula that takes into account the roller material, the roller length and the roller inner and outer diameters (for a solid roller the inner diameter is zero).
   The rollers must have a sufficiently large diameter to ensure that the nip angle between the rollers and the top size particles is sufficient to capture the particle through the applied frictional forces, this being the critical angle above which slippage is likely to occur between the particles and the rollers.
   The diameters of the rollers must be such that the rollers can be balanced to operate at the target rotational speed and such that the centripetal forces experienced by the rollers do not exceed the limits of the chosen roller materials.
The length of the rollers is set by the desired machine throughput. In practice roller lengths are limited by deflection considerations and by commercially available roll dimensions. Roller lengths for most production applications arc expected to range between 2 m and 6 m.
The rollers must be constructed of a material suitable to withstand the compressive forces and unique wear mechanisms associated with single particle fracture. Numerous materials and surface treatments are possible.
The final product exiting from the final set of rollers will usually consist of a fast moving stream (circa 20-30 m/s) of fine particles. The device must be equipped with a suitable receptacle and mechanism to decelerate and transfer these particles to subsequent treatment stages without egress of dust or undue disturbance of the air flows within the device. In practice this may be achieved in numerous ways and with a combination of one or more known technologies. These include, but are not limited to, receiving chambers, baffles, screw conveyors, rotary valves, water sprays, transfer pipes and conveyors.
An integrated control system can be added in most installations in order to monitor the condition of the mono-layer at all crushing stages and make appropriate, real-time adjustments to the roller speeds and roller gaps at each stage and control the overall feed rate into the machine.

These factors for a typical embodiment of the device can improve reliability in accordance with the disclosed method. An inherent feature of the method is that the final crushing stage will be fully utilised (i.e. the majority of the particles entering the gap will be crushed) while the first stage rollers will be required to crush only the relatively few ‘top-size’ particles in the feed. The consequence is that the final roller stage will be the constraint on throughput.

The full device consists of five distinct sub-systems as illustrated in FIGS. 3 and 4:
The Feed System transfers the feed material from a stockpile to the equipment. Control over the maximum size of the feed material assists the proper functioning of the multi-staged roller stack, since over-sized particles can jam and/or cause damage to the initial roller stage. The inclusion of pre-screening and crushing equipment capable of controlling the feed top size (e.g. jaw crusher) is another possible feature. The feed can also be protected from excess moisture and ideally be stored and handled in a manner that minimizes particle segregation, e.g. A-frame stockpile with travelling feeder 1. Excessive particle segregation can impact the quality of the mono-layer and cause uneven wear across the crushing rollers. For wide rolls there may be two feed conveyors 2, passing through tramp removal systems 3 that ensure potentially harmful contaminants (e.g. tramp metal) and oversized particles are detected and removed prior to the Roller Stack. For the most part the Feed System will be constructed from commercially available equipment—tripper distributor, screens, conveyers, hoppers, weightometers, contaminant removal systems (e.g. magnetic or inductive separators, particle sorters) and similar devices.
The Feed Distributor System 4 distributes the feed material across the width of the rolls at the desired feed rate and in the form of a mono-layer 5. The Feed Distributor System may consist of a vibrating distributor or similar technology.
The Multi-staged Roller Stack 6 is the core device of necessary to apply the disclosed method and is described in greater detail hereinbefore.
The Final Product Extraction System 10 decelerates and transfers the crushed particles to subsequent treatment stages without egress of dust or undue disturbance of the air flows within the device may consist of any number of existing technologies, including but not limited to chutes, receiving chambers, baffles, rotary valves, screw conveyers, water sprays, conveyers, pipes and liquid receiving tanks. The products can be loaded onto a final product conveyor or transport system 9.
The Dust and Fine Particle Extraction System consists of an air fan extraction and filtration system 11, a cyclone or similar particle classification device to remove the finer product stream 13, a discharge system to transfer the dust and ultra-fines 12 into the downstream recovery or disposal processes, and the necessary interconnecting ductwork.
Natural fines stack: Most rock or similar feeds to the device will have a wide distribution in the particle sizes. The consequence of this is that the smaller particles ‘take up space’ in the initial roller crushing stages without any crushing being performed on them until they reach the final crushing stages. As illustrated in FIGS. 3 and 4, by screening out the smaller particles 7 before they enter the primary roller stack and redirecting them through a separate roller stack 8 consisting of fewer crushing stages, the overall throughout of the installation can be increased for a relatively low capital outlay. The system for natural fines removal in a typical hard rock mining installation is envisaged to be a form of one or more screens, with classification apertures in the region of 2 to 5 mm in width, but other options may also be utilised.
Split main stack: A similar variation is to split the flow of the particle stream part way along the stack and redirect the resulting flows into two or more stacks. FIG. 5 shows a primary stack 1 which is split part-way down 2 into two secondary stacks 3 which have independent dust extraction outlets 4 and product extraction systems 5. Another possible variant is shown in FIG. 6 side view and FIG. 7 plan view for a system with a primary 1 and optional natural fines stack 2. The primary product is split via interlaced conveyors 3 to separate feed distributors 4 feeding independent secondary roller stacks 5 and 6, that discharge 7 onto the common product conveying system 8. These possible variants similarly increase the overall throughout of the installation for a lower capital outlay than required for a second device.
Devices in parallel: A single stockpile can feed multiple devices in parallel, as illustrated in FIG. 8 with two parallel roller stacks.
Progressively longer rollers: A third variation is to increase the length of the rollers with each successive crushing stage, with appropriate ancillary equipment and design modifications to spread out the mono-layer and ensure the necessary rigidity of the longer rollers.
·Air scalping: A suitably sized air flow and ducting system can be used to scalp out dust and finer particles from any or all of the crushing stages. The rollers are housed in a dust-tight enclosure and one or more aspiration/air extraction connections are utilised to remove airborne dust and fines as they are produced (nominally minus 250 μm but this is dependent on the application). The air for dust and fines extraction can be blown or sucked in, and can be withdrawn as required from multiple points along the full span of the roller stack, such as illustrated in FIG. 3 by the multiple flows 15. The extracted air with associated suspended dust and fine particles can then be drawn into a common airduct, or kept in a number of separate ducts for transport to the air separation and dust capture facility, such as, but not restricted to, a bag-house.

### Batch System

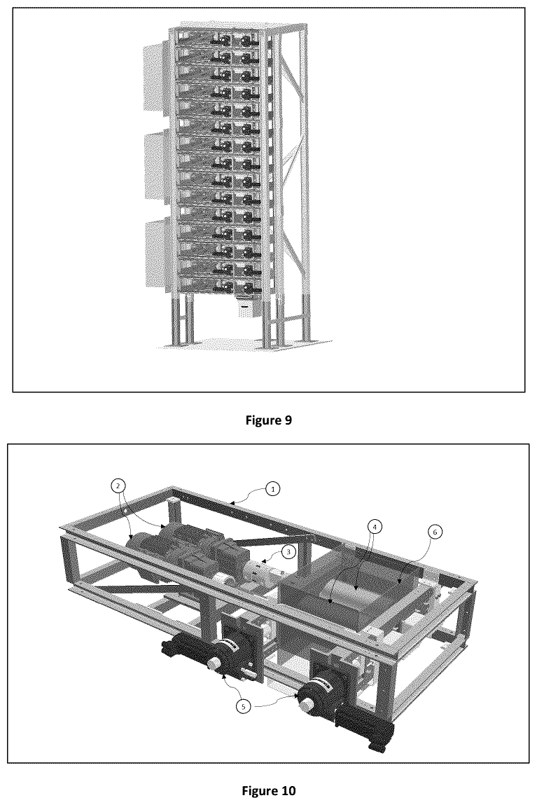

The design of a batch crushing system for laboratory trials is illustrated in projection views. FIG. 9 shows a stacked 15-rolls set, without the feed and product collection systems illustrated. FIG. 10 shows a projection view of a single stage of rollers, showing the rigid frame 1, independent drive motors 2, drive couplings 3, rollers 4, gap adjustment drives 5, and dust cladding 6.

### Calculation of Operating Parameters for Each Crushing Stage:

The number of stages ‘n’ is a mathematical function that depends on the overall reduction required (Top Size/Final Size) and the reduction ratios between each crushing stage. For a simple roller stack with a constant reduction ratio (RR) between each stage, the number of stages can be determined by the formula:

$$n = log ( TS / FS ) / log ( R R )$$

In practice, the Final Size (FS) is determined by the downstream process requirements, the Top Size (TS) by the most economic configuration and operation of the feed crushing circuit, and the Reduction Ratio must be within a range suitable for single particle breakage (as discussed earlier in this document).

Each of the ‘n’ roller crushing stages must be operated to process the same throughput of material (in the absence of any air or other inter-stage extraction) while at the same time achieving optimal particle fracture conditions. The practical limitation of the throughput is set by the final roller stage and the operating parameters of each preceding stage must be synchronised with those of the final stage. The capacity of any roller stage is a simple mathematical function of the roller length and tangential velocity, the gap, the material density and the material volumetric packing. In practice there are limitations on each of these parameters:
The final gap size is set by the downstream process requirements.
The speed at which a roller can spin is limited by the structural strength of the steel and the quality of the roller balancing.
The length of the roller is limited by the permitted deflection of the roller (which in turn is related to the required final gap). This deflection is a function of the roller length, diameter and construction material.
The volumetric packing is a function of the size distribution of the particles and will change during the staged crushing process.

Hence the maximum throughput of a machine with ‘n’ crushing stages is given by:

Throughput (tph)=Rollerₙ Speed (RPM)×Rollerₙ diameter×Pi×Rollerₙ length×Gapₙ×volumetric packingₙ×particle density×60

Each preceding stage is then controlled to operate as follows:

Gapₙ₋₁=Gapₙ×Reduction ratio

Rollerₙ₋₁ Speed (RPM)=Rollerₙ Speed (RPM)/Reduction Ratio×(Volumetric Packingₙ₋₁/Volumetric Packingₙ)

An example of these operating parameters calculated for a 500 tph device is provided in Table 1. This roller stack consists of 23 stages of 6 m long rolls of the stated diameter at each stage. The stack splits into two from stage 14 onwards (this is denoted by number of crushing stages) so as to minimise vertical height and allow for the feed to be distributed to more sets of rollers at the finer end of the stack (where capacity is constrained). Two different reduction ratios are used in this example.

### Experimental Support for the Method and Device

A number of ores have been tested in a laboratory scale embodiment of the device, illustrated in FIG. 11. For economic and space considerations, this device consists of just three roller crushing stages, so the material to be crushed must be repeatedly passed through the device to achieve the same degree of size reduction as in a full stack.

The results are illustrated as a progressive particle size distribution after each pass of three rolls, with a photograph of the final product alongside it. FIG. 12 shows the results for a copper ore, and FIG. 13 shows the results for an iron ore. The overlap of pass 5 with pass 4 is due to removing final product (−250 μm) from the feed after pass 4. These illustrate the viability of the equipment and that very narrow product size distributions can be achieved.

Energy consumption figures are provided in kW hours per tonne (kWh/t) crushed to the final product size. The feed and product size distributions for seven ores tested in the laboratory rig are shown in FIG. 14, along with the low energy consumptions. A comparison of the roller-mill product size with conventional product size for a Zinc ore is shown in FIG. 15, starting from the same feed size distribution. The ore requires 15.5 kWh/t to be ground to final product size in a production ball mill. For the rollers device, the energy use was 2.2 kWh/t to achieve a product size of P80 (80 percent of the product passing the given size)=95 μm, or 1.8 kWh/t to reach a P80=170 μm.

In terms of required final product size, the energy fraction to achieve the top-size of the milled product is in the range of 11.6% to 14% of the production mills for this ore.

The size distribution of the feed and a range of products for a copper ore are shown in FIG. 16, compared to the product from an operating milling circuit. The equipment utilised at most 15% (1.5 kWh/t relative to 10.0 kWh/t) of the energy of the production equipment to produce a product in the same range of size, and in the recovery window.

Experimental Basis for Single Particle Breakage with Low Reduction Ratios

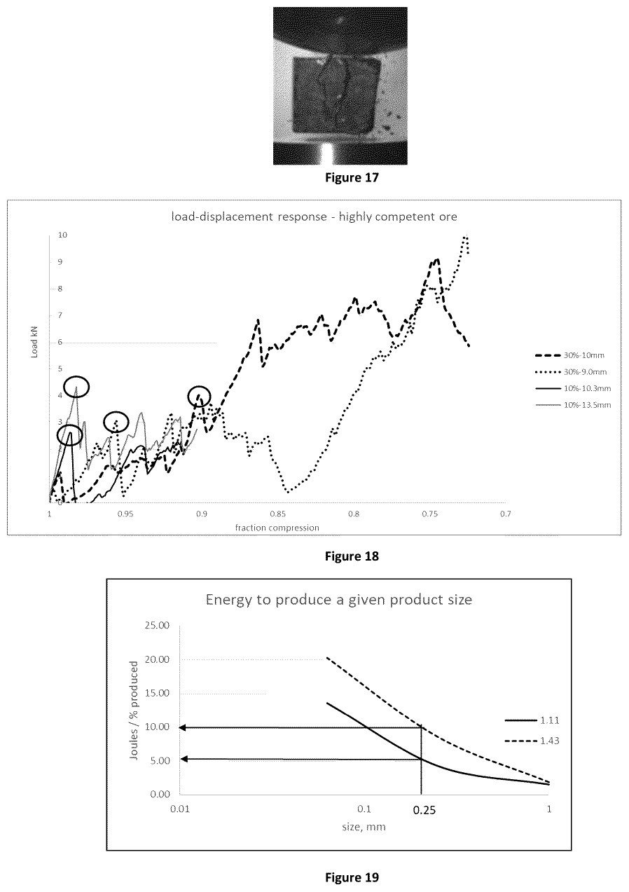

The requirement of a limited reduction ratio is illustrated by some single rock compression tests. The rocks are squeezed under an increasing load and the degree of compression measured for tests conducted for two different degrees of compression. A typical such fracture event in a laboratory apparatus is shown in FIG. 17. When single particle compression breakage tests are conducted on natural rock the applied load can be measured as a function of the fraction of compression, as shown in FIG. 18. The circles highlight the breakage point of each rock, showing typical results for natural hard rock. For this test work two degrees of total reduction were applied, 1.11 (solid lines) and 1.43 (dotted lines). When compiling many such tests with a range of applied reduction ratios, the energy to fracture for different reduction ratios can be compared, as shown for a set of work in FIG. 19. This provides a plot of the energy in Joules to produce a percentage of final product, given by the size on the x-axis. The higher reduction ratio (1.43) requires considerably more energy to produce the same amount of final product below a given size, with double the energy at 0.25 mm product, compared to the lower reduction ratio of 1.11. This supports the need to maintain the reduction ratio preferably below 1.4.

### Rolls Compression Force

The loading, or compressive force, required to fracture a particle is given in FIG. 18 at around 3-4 kN for a competent 11 mm rock. Calculating the force along the rolls, requires knowledge of the packing density of particles in the gap and the percentage of particles of greater size than the gap, to estimate the loading force. An example from the above data is provided in Table 2. This predicts a likely loading force per meter of roll length.

The equivalent calculation for a bed breakage device, such as an HPGR, is shown in Table 3. This is based on compression tests conducted in a Piston and Die apparatus (P&D) where the compressive force is accurately measured as the bed of particles is compressed. The relative forces are shown by the force per meter of roll length, in kN. The derived range of values are 25 to 50 for the monolayer breakage device and 9 000 to 15 000 kN for the compression device—which is over 100 times the applied force.

This dramatic difference in applied load illustrates the fundamental difference between operating a roller crushing device under mono-layer breakage conditions, as in the device claim, compared to utilising bed breakage as is standard in production rolls crushing devices used for rock breakage.

### Narrow Particle Size Distribution

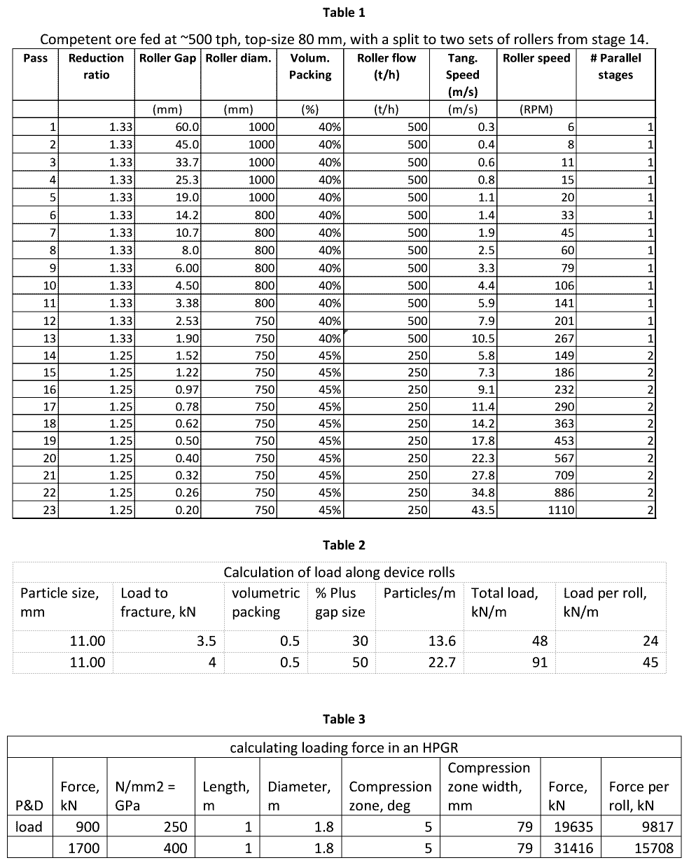

The roller crushing device is suited to producing a narrow and controllable size distribution, within the limit of the natural fragmentation size distribution of particles when subjected to single particle breakage. FIG. 21 is an example product size distribution that shows the production mill product size distribution compared to two size distributions produced by the rollers. The products from the rollers are far steeper, providing a narrow size range that can be selected to suit the needs of the downstream recovery process. The rollers product size distribution can be chosen to fall anywhere between these two examples (and even coarser if desired) by controlling the final rollers gap size. The rollers' product can be chosen to have over 90% of product in the recovery zone of 40 to 400 μm, whereas the mill product has only 50% in this range. For a narrower size range (shown by the inner rectangle) of 60 to 300 μm, the rollers can achieve over 80% while the mill achieves only 44% in the desired size range.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “upper” and “lower”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, the inventions have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the inventions. Also, the various embodiments described above may be implemented in conjunction with other embodiments, e.g., aspects of one embodiment may be combined with aspects of another embodiment to realise yet other embodiments. Further, each independent feature or component of any given assembly may constitute an additional embodiment.

1-5. (canceled)

6. The roller crushing machine as claimed in claim 24, wherein the predetermined lateral distance between the roller pairs located in the or each crushing stage(s) are in respective angled alignment in relation to vertical, said flow path of particulates passing therethrough is also angled other than in a vertical orientation, and the outer peripheral surfaces of the roller pairs in the crushing stages are adjustably displaceable with respect to each other.

7. (canceled)

8. The roller crushing machine as claimed in claim 24, operatively connected to a control system which is arranged in use to adjust at least one of: (i) the predetermined lateral distance between the roller pair located in a crushing stage, and (ii) the rate of rotational motion of each roller in a roller pair located in a crushing stage.

9-11. (canceled)

12. The roller crushing machine as claimed in claim 33, wherein in use, the control system takes an output signal from a signal transmission device for the distance measurement sensor, and provides an input signal to a control device for a motorised drive to adjust the relative displacement of said component(s) and therefore the predetermined lateral distance between the roller pairs.

13-23. (canceled)

24. A roller crushing machine for progressively crushing solid particulate material into finer size particulates, the machine comprising a plurality of spaced-apart crushing stages arranged so that, during use, a flow path of said particulates travels consecutively from one crushing stage to the next, each crushing stage comprising:
a pair of rollers, each mounted for rotational motion about an elongate axis, each roller of said pair along with its respective drive transmission mechanism representing a functional unit which is located at a support; and
respective outer peripheral surfaces of the rollers in each crushing stage being adjustably displaceably set apart from each other in use by a predetermined lateral distance which is in alignment with the flow path and perpendicular to the flow direction which is received in use onto, and drawn between, the pair of rollers;
wherein when progressing consecutively through the crushing stages:
the predetermined lateral distance encountered by the flow path in use is adjustable to be smaller than the predetermined lateral distance in any preceding crushing stage; and
the rollers in said crushing stages in use are operable with a tangential velocity which is faster than that of the rollers located in any preceding crushing stage; and
wherein for a preselected solid particulate material being passed through the machine, said predetermined lateral distance in each crushing stage is arranged of a dimension which is sufficiently operably narrow to provide sufficient compression breakage of just the topsize of the particulates at that particular size range of preselected solid particulate material.

25. The roller crushing machine as claimed in claim 24, wherein said predetermined lateral distance in each crushing stage is arranged of a dimension which is sufficiently operably narrow to inhibit the formation of a bed of multiple particulates thereacross, at that particular size range of preselected solid particulate material.

26. (canceled)

27. A comminution system for crushing solid particulate materials into finer size particulates, the system comprising:
a comminution machine in which a plurality of spaced-apart comminution stages are arranged so that, during use, a flow path of said particulates travels consecutively from one comminution stage to the next; and
each comminution stage including a pair of rollers mounted for rotational motion about an elongate axis, each roller of said pair along with its respective drive transmission mechanism representing a functional unit; and
respective outer peripheral surfaces of said rollers in a comminution stage are adjustably displaceably set apart from each other by a predetermined lateral distance not greater than a desired maximum particulate size from that comminution stage, said lateral distance being in alignment with the flow path and perpendicular to the flow direction of solid particulate material which is received in use onto, and drawn between, the pair of rollers;
said comminution stages being arranged so that, in use:
the rate of rotational motion of the rollers in a comminution stage is operably adjusted such that the tangential velocity is faster than that of the rollers located in a preceding comminution stage; and
the predetermined lateral distance in a comminution stage is smaller than the predetermined lateral distance in a preceding comminution stage;
wherein the comminution system further comprises:
a sensing device which measures a physical parameter indicative of the energy being applied to operate the or each functional unit in a comminution stage; and
a controller which produces a signal to control at least one component of a functional unit in a comminution stage, to maintain the flow of particulates passing therethrough to a stipulated value, and to minimize overall energy consumption in said comminution stage.

28. The comminution system as claimed in claim 27, wherein the at least one property of a functional unit in a comminution stage which is controllable in use to maintain the flow of particulates passing therethrough to a stipulated value, and to minimize overall energy consumption in said comminution stage, is from the group comprising:
the rate of rotational motion of each roller in a roller pair; and
width of the predetermined lateral distance between each roller in a roller pair.

29. The comminution system as claimed in claim 28, wherein the rate of rotational motion of each roller of a functional unit in a comminution stage can be controlled, in use so as to inhibit the formation of a bed of multiple particulates thereacross at a particular size range of solid particulate material, and to maintain a mono-layer flow of particles passing therethrough, thereby minimizing energy consumption in that stage.

30. The comminution system as claimed in claim 28, wherein the predetermined lateral distance between each roller of a functional unit in a comminution stage can be controlled to be of a dimension which is sufficiently operably narrow to just apply a sufficient compression breakage force to only the topsize of the particulates at that particular size range of preselected solid particulate material, but not their progeny, and in so doing, inhibiting the formation of a bed of multiple particulates thereacross, and maintaining a mono-layer flow of particles passing therethrough, and to thereby minimize energy consumption in that stage.

31. (canceled)

32. The comminution system as claimed in to claim 31, wherein the physical parameter indicative of the energy being applied to operate the or each functional unit in a comminution stage in use is rotational torque, and the sensing device is a torque meter.

33. The comminution system as claimed in claim 28, wherein the physical parameter indicative of the predetermined lateral distance between the roller pairs in a comminution stage in use is the displacement between the outer peripheral surface of the rollers components, and the sensing device is a distance measurement sensor.

34. The comminution system as claimed in claim 28, further comprising the step of managing and maintaining the evenness of the flow properties of solid particulate materials, prior to feeding such materials into the comminution machine.

35. (canceled)

36. The comminution system as claimed in claim 28, further comprising using dust and fine particle extraction apparatus for separation of such products from multiple locations, during operation of the comminution machine.

37. The comminution system as claimed in claim 36, comprising the step of removal of at least some of the naturally-occurring fine particles by screening from the feed stream of solid particulate materials, prior to the remainder of the feed material entering the comminution machine.

38. A method of crushing solid particulate material into finer size particulates, the method comprising the steps of:
causing the rollers of a plurality of pairs of rollers, to rotate about respective parallel elongate axes, and
supplying a solid particulate material successively through a gap between each pair of a plurality of pairs of laterally spaced-apart rotatable pairs of rollers, in which each pair defines a crushing stage,
said gap between the rollers of each pair of rollers having been selected to crush a topsize only of the solid particulate material by contact of the topsize solid particulate material with the rotating surfaces of the rollers of the pair;
wherein the gap between the rollers of an upstream pair of rollers in the direction of movement of the solid particulate material is greater than the gap between the rollers of at least one successive downstream pair of rollers in the direction of movement of the solid particulate material, and wherein the tangential velocity of the rollers of said downstream pair of rollers is faster than the tangential velocity of said upstream pair of rollers, so that the solid particulate material is crushed into finer particulates when moving through the gaps between the rollers of the successive pairs of rollers.

39-40. (canceled)

41. The method as claimed in claim 38, comprising selection of the numbers of pair of rollers and the sizes of the lateral gaps between the roller pairs so that less than 30% by weight of the solid particulate material passes through each pair of rollers at the topsize solid particulate material, thus giving a gradual, sequential grinding process.

42. The method as claimed in claim 38, wherein the solid particulate material is a mined ore.

43. The roller crushing machine as claimed in claim 24, wherein when progressing consecutively through the crushing stages, the predetermined lateral distance encountered by the flow path in use is adjustable to be relatively smaller than the predetermined lateral distance in a preceding crushing stage by a preselected numerical ratio which is within the range of greater than 1 and less than 2.

44. The roller crushing machine as claimed in claim 24, wherein the adjustment of the relative displacement of at least one of the following components of a crushing stage in relation to that crushing stage: a functional unit, a component of which is operably connected to the roller of a functional unit; or a roller, which is arranged in use to provide an operable precision of adjustment of the predetermined lateral distance between the roller pairs to within 20% thereof.

45. The roller crushing machine as claimed in claim 24, wherein each roller in the pair of rollers in any one of said crushing stages in use is operable with a tangential velocity within 5% of the respective other roller.
